(19) United States
(12) Patent Application Publication
(10) Pub. No.: US 2005/0048367 A1
(43) Pub. Date: Mar. 3, 2005

(54) Non-aqueous electrolyte secondary battery, method for producing the same, and electrode material for electrolyte secondary battery

(75) Inventors: Emiko Igaki, Amagasaki-shi (JP); Masakazu Tanahashi, Osaka-shi (JP); Miyuki Nakai, Izumi-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/902,211

(22) Filed: Jul. 29, 2004

(30) Foreign Application Priority Data
Jul. 29, 2003 (JP) 2003-282051
Jul. 29, 2003 (JP) 2003-282053

(51) Int. Cl. H01M 4/60; G01L 1/20

(52) U.S. Cl. 429/212; 429/217

(57) ABSTRACT

A non-aqueous electrolyte secondary battery of the present invention includes a positive electrode including a layer of active material particles, a negative electrode including a layer of active material particles and a non-aqueous electrolyte. An organic film including a conductive agent and having a low affinity to the non-aqueous electrolyte is formed on a portion of at least one electrode selected from the positive electrode and the negative electrode. Accordingly, there are provided a non-aqueous electrolyte secondary battery that exhibits a small decrease in capacity during repeated charge/discharge, a method for producing the same and an electrode material for an electrolyte battery.

### BACKGROUND OF THE INVENTION

1. Field of the Invention

The present invention relates to non-aqueous electrolyte secondary batteries, methods for producing the same, and electrode materials for electrolyte secondary batteries, and particularly to lithium secondary batteries, for example.

2. Description of the Related Art

Recently, non-aqueous electrolyte secondary batteries, in particular lithium secondary batteries, are being developed as secondary batteries having a high voltage and a high energy density. For example, lithium secondary batteries that exhibit a small decrease in capacity even after repeated charge/discharge, i.e., have good cycle characteristics, are being developed.

One of the factors of the capacity decrease with charge/discharge is the presence of a film formed on the surface of the active material layer. This film is formed by the decomposition product of the constituents of the electrolyte during charge/discharge. This film has a low conductivity, so that the formation of this film leads to an increase in the internal resistance of the battery. Therefore, the internal resistance of the battery increases with an increase in the number of repetitions of charge/discharge, resulting in a decrease in capacity. In addition, the studies made by the inventors have revealed that the presence of a film formed on the surface of the current collector is another factor of the capacity decrease with increased repetitions of charge/discharge. Similarly, this film is formed by the decomposition products of the constituents of the electrolyte or by the surface oxidation of the current collector, and causes an increase in the internal resistance.

As a method for producing a lithium ion secondary battery having good cycle characteristics, a method of forming a stable film called SEI (Solid Electrolyte Interface) on the surface of the negative electrode has been proposed (e.g., JP H11-111267A). This method is aimed at forming a stable film, thereby preventing the formation of a further film.

The active material layer of the electrode plate of a non-aqueous electrolyte secondary battery repeatedly undergoes swelling and contraction with charge/discharge. Therefore, gaps may be formed between the particles in the active material layers with continued charge/discharge. Similarly, gaps may be formed between the current collector and the active material layer due to an occurrence of a partial separation between them. When the electrolyte permeates into the gaps, a film may be formed on the surface of the active material particles or the surface of the current collector during continued charge/discharge. When the formation of such a film proceeds, the internal resistance of the battery increases, causing degradation of the battery characteristics such as the cycle life.

### SUMMARY OF THE INVENTION

Therefore, with the foregoing in mind, the present invention provides a non-aqueous electrolyte secondary battery that exhibits a small decrease in capacity during repeated charge/discharge, a method for producing the same, and an electrode material for electrolyte secondary batteries.

A non-aqueous electrolyte secondary battery of the present invention includes a positive electrode including a layer of active material particles; a negative electrode including a layer of active material particles; and a non-aqueous electrolyte, wherein an organic film including a conductive agent and having a low affinity to the non-aqueous electrolyte is formed on a portion of at least one electrode selected from the positive electrode and the negative electrode.

A first method for forming a non-aqueous electrolyte secondary battery of the present invention is a method for producing a non-aqueous electrolyte secondary battery including a positive electrode including a layer of active material particles, a negative electrode including a layer of active material particles and a non-aqueous electrolyte. The method includes: forming at least one electrode selected from the positive electrode and the negative electrode with the active material particles after forming an organic film having a low affinity to the non-aqueous electrolyte on a surface of the active material particles.

A second method for producing a non-aqueous electrolyte of the present invention is a method for producing a non-aqueous electrolyte secondary battery including a positive electrode including a layer of active material particles, a negative electrode including a layer of active material particles and a non-aqueous electrolyte. The method includes: forming an active material layer including at least one active material selected from a positive electrode active material and a negative electrode active material on a current collector; and impregnating the active material layer with a liquid including a film material having a low affinity to the non-aqueous electrolyte.

A third method for producing a non-aqueous electrolyte secondary battery of the present invention is a method for producing a non-aqueous electrolyte secondary battery including a positive electrode including a layer of active material particles, a negative electrode including a layer of active material particles and a non-aqueous electrolyte. The method includes: forming an underlayer including an organic film having a low affinity to the non-aqueous electrolyte on a surface of a current collector of at least one electrode selected from the positive electrode and the negative electrode; and forming an active material layer electrically connected to the current collector on the underlayer.

An electrode material for a non-aqueous electrolyte secondary battery of the present invention is an electrode material including active material particles for a non-aqueous electrolyte secondary battery, wherein an organic film having a low affinity to the non-aqueous electrolyte is formed on a portion of a surface of the active material particles.

### BRIEF DESCRIPTION OF THE DRAWINGS

FIG. 1 is a cross-sectional view schematically showing an electrode containing an example of an electrode material of the present invention.

FIG. 2 is a cross-sectional view schematically showing the configuration of an example of a non-aqueous electrolyte secondary battery of the present invention.

FIG. 3 is a cross-sectional view schematically showing the structure of an example of an electrode for a non-aqueous electrolyte secondary battery of the present invention.

FIG. 4 is a cross-sectional view schematically showing the structure of an example of an electrode for a non-aqueous electrolyte secondary battery of the present invention.

FIG. 5 is a cross-sectional view schematically showing the structure of another example of an electrode for a non-aqueous electrolyte secondary battery of the present invention.

FIGS. 6A to 6C are cross-sectional views schematically showing an example of the steps of a production method of the present invention.

### DESCRIPTION OF THE PREFERRED EMBODIMENTS

(1) Electrode Material Used for Non-Aqueous Electrolyte Secondary Battery

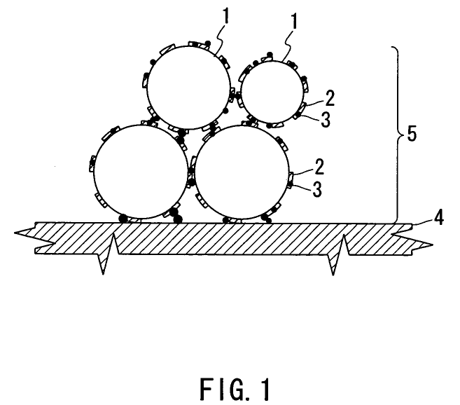

An electrode material used in the present invention is powder containing active material particles. An organic film is formed on a portion of the surface of the active material particles. FIG. 1 shows a schematic cross-sectional view of an electrode containing this electrode material. An active material layer 5 is formed on a current collector 4, and the active material layer 5 contains a powder (active material powder) made up of active material particles 1 (without hatching). On a portion of the surface of the active material particles 1, an organic film 2 is formed. The organic film 2 contains a conductive agent 3. The conductive agent 3 either may be embedded inside the organic film 2, or may penetrate the organic film 2.

When the electrode material is a positive electrode material, the active material particles 1 are particles containing a positive electrode active material as the main component (normally, at least 90 wt %). As the active material particles 1, it is possible to use, for example, particles including a lithium-containing composite oxide such as LiCoO₂, LiNiO₂, LiMnO₂ or LiMn₂O₄. Co, Mn and Ni may be replaced partially by other metal elements.

When the electrode material is a negative electrode material, the active material particles 1 are particles containing a negative electrode active material as the main component (normally, at least 90 wt %). It is possible to use, for example, particles including a metallic material, a carbonaceous material, a conductive polymer material, metallic lithium or a lithium alloy, each of which can be doped or intercalated with lithium ions.

There is no particular limitation with respect to the size of the active material particles 1, and it is possible to use any size commonly used for the active material particles of non-aqueous electrolyte secondary batteries. The average particle size of the active material particles 1 may be, for example, about 2 μm to about 10 μm.

As the conductive agent 3, it is possible to use a conductive powder, and examples include acetylene black, carbon black and graphite powder.

The organic film 2 may contain a binder. As the binder, it is possible to use a compound capable of binding the substances in the film. Examples includes: rubber-based binders such as hydrogenated nitrile butadiene rubber (HNBR), hydrogenated styrene butadiene rubber (HSBR), polyvinyl alcohol (PVA), polyethylene (PE), styrene butadiene rubber (SBR) and nitrile butadiene rubber (NBR); and fluorocarbon resin-based binders such as polyvinylidene fluoride (PVDF), polytetrafluoroethylene (PTFE) and polytrifluoroethylene (PTrFE). At least one selected from this group is used as the binder. When the organic film 2 contains a binder, the content percentage of the binder is 5 wt % to 30 wt %, for example. The thickness of the organic film 2 can be made relatively large by increasing the content of the conductive agent or the binder in the organic film 2. In addition, the thickness of the organic film 2 may be selected based on the properties, workability, cost effectiveness and the like of the film material.

The organic film 2 includes a film (hereinafter, occasionally referred to as “film A”) having a low affinity (i.e., low wettability) for the electrolyte used in the battery. Here, the non-aqueous electrolyte is, for example, a non-aqueous electrolyte in which LiPF₆ is dissolved at a concentration of 1 M in a mixed solvent of ethylene carbonate and methyl ethyl carbonate with a volume ratio of 1:2.

The organic film 2 having a low affinity to the non-aqueous electrolyte used in the battery is a layer having a low wettability with the non-aqueous electrolyte. In the present invention, “having a low affinity to the non-aqueous electrolyte” means that the contact angle formed by the organic film 2 and the non-aqueous electrolyte is at least 20°. Preferably, the contact angle is at least 30° and at most 90°. More preferably, the contact angle is at least 30° and at most 80°. The content of the film material in the organic film 2 may be any value as long as the organic film 2 can exert its property of repelling the non-aqueous electrolyte. The content is, for example, at least 5 wt %, and preferably at least 30 wt %.

As the organic film, it is possible to use, for example, at least one organic film selected from the group consisting of a fluorine-based silane compound, a fluorine-based coating agent, polybutadiene, pitch and a perfluoroalkyl ester of polyacrylic acid, having a low affinity with respect to the non-aqueous electrolyte.

Examples of the fluorine-based silane compound include the compound represented by the following general formula (1):
CₙF₂ₙ₊₁—(CH₂)ₘ—Si(OR¹)(OR²)(OR³) (1)
where n is an integer of at least 2, preferably at least 4 and at most 16, m is an integer of at least 1, preferably at least 2 and at most 4, and R¹, R² and R³ each independently represent an alkyl group, preferably an alkyl group having 1 to 4 carbon atoms.

In an example of the compound represented by the above-described general formula (1), n=8, m=2 and all of R¹, R² and R³ are methyl groups.

The compound represented by the general formula (1) is fixed to the surface of a substrate via covalent bonds through a dealcoholization reaction with active hydrogen in the substrate.

Examples of the perfluoroalkyl ester of polyacrylic acid include an organic film represented by a repeating unit of the following general formula (2):
—(CH₂—CR⁴R⁵)ₘ—(CH₂—CR⁶R⁷)ₙ—(CH₂—CHCl)ₚ—(X)_{L}— (2)
where R⁴ represents a methyl group or hydrogen, R⁵ is a —COO—(CH₂)₂— (CF₂)_{q}CF₃ group (where q is an integer of at least 2, and preferably an integer of at most 18), R⁶ represents a methyl group or hydrogen, R⁷ is a —COO— (CH₂)ᵣCH₃ group (where r is an integer of at least 4, and preferably an integer of at least 12 and at most 20), and X represents a cross-linking monomer. m, n, p, L and q are natural numbers.

The polymer represented by the above-described general formula (2) is a random copolymer.

Covering the entire surface of the active material particles 1 by the organic film 2 causes a reduction in ionic reactivity of the battery, so that the proportion of the area occupied by the organic film 2 on the surface of the active material particles 1 is preferably at least 10% and less than 90%, and more preferably at least 50% and at most 80%, on average.

A film having a low affinity to the non-aqueous electrolyte used in the battery is formed on the active material particles of the above-described electrode material. Therefore, a non-aqueous electrolyte secondary battery that exhibits a small decrease in capacity during repeated charge/discharge can be constructed, as described below.

(2) Non-Aqueous Electrolyte Secondary Battery of the Present Invention

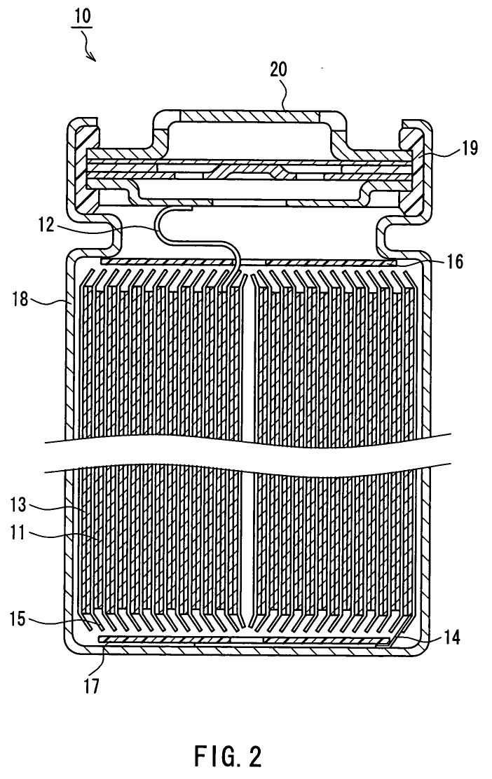

FIG. 2 schematically shows a cross-sectional view of a non-aqueous electrolyte secondary battery 10 (hereinafter, occasionally referred to as “secondary battery 10”) in an example of the present invention.

Referring to FIG. 2, the secondary battery 10 is provided with a positive electrode 11, a positive electrode lead 12, a negative electrode 13, a negative electrode lead 14, a separator 15, an upper insulating plate 16, a lower insulating plate 17, a battery case 18, an insulating gasket 19, a lid 20 and a non-aqueous electrolyte (not shown) encapsulated in the battery case 18.

The positive electrode 11 and the negative electrode 13 are wound in a spiral fashion with the separator 15 made of polyethylene resin interposed therebetween, forming an electrode assembly (battery element). This electrode assembly is housed in the battery case 18. The positive electrode lead 12 is connected to the positive electrode 11, and the lid 20 serving as a positive electrode terminal and the positive electrode 11 are connected electrically by this positive electrode lead 12. A negative electrode lead 14 is connected to the negative electrode 13. The battery case 18 serving as a negative electrode terminal and the negative electrode 13 are connected electrically by this negative electrode lead 14. The battery case 18 is sealed by the insulating gasket 19 and the lid 20. When the secondary battery 10 is a lithium secondary battery such as a lithium ion secondary battery, both of the positive electrode and the negative electrode are electrode plates that reversibly absorb and desorb lithium.

Except for the electrode material, any components that conventionally have been used or proposed can be used as the components of a battery of the present invention. As the separator, nonwoven fabric made of a synthetic resin, including polyolefin such as polyethylene or polypropylene, or a porous film made of polyolefin such as polyethylene or polypropylene is used, for example. Preferably, the thickness of the separator is in the range from 15 μm to 30 μm.

In the secondary battery 10, at least one electrode selected from the positive electrode 11 and the negative electrode 13 (the positive electrode, the negative electrode, or both) contains the electrode material described in the above section (1). This electrode plate includes a current collector and an active material layer formed on the current collector, and the active material layer contains the above-described electrode material. When the electrode material described in the above section (1) is not used in one of the positive electrode and the negative electrode, a common electrode material may be used.

In the case of the positive electrode, for example, aluminum foil is used as the current collector. In the case of the negative electrode, for example, copper foil is used as the current collector.

The active material layer formed on the current collector may contain other additives such as a binder and a conductive agent, in addition to the electrode material. As the conductive agent, a conductive powder can be used, and examples include acetylene black, carbon black and graphite powder. As the binder, a compound capable of binding the substances in the layer may be used. Examples include rubber-based binders such as hydrogenated nitrile butadiene rubber (HNBR), hydrogenated styrene butadiene rubber (HSBR), polyvinyl alcohol (PVA), polyethylene (PE), styrene butadiene rubber (SBR) and nitrile butadiene rubber (NBR). Alternatively, it is possible to use fluorocarbon resin-based binders such as polyvinylidene fluoride (PVDF), polytetrafluoroethylene (PTFE) and polytrifluoroethylene (PTrFE). At least one selected from this group may be used as the binder. Preferably, the active material layer contains the binder in the range from 2 to 10 parts by weight per 100 parts by weight of the electrode material serving as an active material.

As the non-aqueous electrolyte encapsulated in the battery case 18, it is possible to use an electrolyte commonly used for non-aqueous electrolyte secondary batteries. Specifically, in the case of lithium secondary batteries, for example, an electrolyte obtained by dissolving a lithium salt in a non-aqueous solvent is used. Examples of the non-aqueous solvent include a mixed solvent containing propylene carbonate, ethylene carbonate or the like and dimethyl carbonate, methyl ethyl carbonate, diethyl carbonate, γ-butyrolactone, 1,2-dimethoxyethane, 1,2-diethoxyethane, ethoxymethoxyethane or the like. Examples of the lithium salt include LiPF₆, LiBF₄, LiClO₄, LiAsF₆ and LiCF₃SO₃.

In this secondary battery 10, the non-aqueous electrolyte permeates into the active material layer. The organic film 2 formed partially on the surface of the active material particles 1 suppresses the wettability of a portion of the active material particles with the non-aqueous electrolyte. This inhibits the formation of a film resulting from the electrolyte on the entire surface of the active material particles 1. Consequently, the amount of a film formed in the battery as a whole is reduced.

Furthermore, in this secondary battery 10, even when the active material layer is partially separated due to the swelling and contraction of the active material layer with repeated charge/discharge, the permeation of the electrolyte into the separated portion can be inhibited by the presence of the organic film 2, so that the separated portion will not be covered by the film entirely. Accordingly, the separated portion comes into contact with the current collector again during charging, maintaining the conductivity.

On the other hand, since the organic film 2 on the surface of the active material particles 1 contains a conductive agent, sufficient conductivity is ensured between the active material particles and between the active material and the current collector. In the battery of the present invention, even when the active material particles 1 with the organic film 2 formed on the surface undergo repeated charge/discharge, the conductivity is maintained since there is a portion where the film is not formed. Therefore, it is possible to suppress the increase in internal resistance with repeated charge/discharge. Since there is a portion on the surface of the active material particles 1 where the organic film 2 is not formed, the ionic conductivity on the surface of the active material particles 1 can be ensured to the extent embodied in conventional batteries and the ionic reactions in the battery thus are not disturbed. For these reasons, the present invention can suppresses an increase in internal resistance due to repeated charge/discharge cycles and a decrease in discharge capacity resulting from such increase in lithium secondary batteries.

(3) Method for Producing Electrode Material and Non-Aqueous Electrolyte Secondary Battery of the Present Invention

First, a liquid (hereinafter, occasionally referred to as “liquid A”) containing a film material A having a low affinity to a non-aqueous electrolyte used in the battery is prepared (step (i)). As the film material A, the one described in the above section (1) regarding the electrode material is used.

The solvent or dispersion medium for the liquid A may be any solvent or dispersion medium in which the film material A can be dissolved or dispersed homogeneously, and may be selected in accordance with the film A. The liquid A may, as necessary, contain additives such as a conductive agent and/or a binder. As these additives, those described in the section (1) regarding the electrode material can be used. The content of the film material A in the liquid A is, for example, 0.5 wt % to 10 wt %.

Next, the film is formed on a portion of the surface of the active material particles by applying the liquid A onto the surface of the active material particles (step (ii)) The step (ii) provides an electrode material described in the above section (1). As the method for applying the liquid A onto the surface of the active material particles, it is possible to use, for example, a method of applying the liquid A onto the surface of the active material particles, followed by drying, or a method of immersing the active material particles in the liquid A, and subsequently raising and drying the active material particles. At this time, the proportion of the area occupied by the film on the surface of the active material particles is preferably at least 10% and less than 90% (more preferably at least 50% and at most 80%), on average. The proportion of the area occupied by the film can be varied by, for example, adjusting the content of the film material.

A non-aqueous electrolyte secondary battery of the present invention can be produced by using the thus obtained electrode material. First, a slurry is produced using the electrode material (active material). The electrode material is selected in accordance with the electrode plate (positive electrode or negative electrode) to be produced. Generally, the slurry contains a conductive agent, a binder and the like. When the slurry is produced, it is possible to mix the electrode material and a conductive agent first, and then to mix a binder. This slurry is applied onto a current collector, then dried and rolled. Preferably, the rolling is performed with a roller heated at 40° C. to 90° C. The binder contained in the slurry is softened by heating the roller, thereby achieving the following effects. First, the filling density of the active material can be increased easily, and a desired filling density can be achieved with reduced frequency of rolling. Second, the change in the thickness of the electrode plate after rolling can be suppressed. Third, since the softening of the binder increases the area where the binder exerts its effects, it is possible to improve the adhesion between the active material particles and between an underlayer and the positive electrode active material layer and thus to improve the battery characteristics.

When the liquid A contains a conductive agent, the film formed by the step (ii) will contain a conductive agent. In this case, a thin organic film 2 (having a thickness corresponding to about one to several molecules of the constituent molecules of the film) with a surface occupation of 10% to 90%, (preferably 50% to 80%) can be formed by using a liquid A that contains a conductive agent (e.g., acetylene black) such that the weight proportion of the conductive agent to the film after drying is, for example, 20 wt % and contains the film material in a weight proportion of 5 wt %. Whether the surface occupation is 10% to 90% (preferably 50% to 80%), with the total area of the active material particles taken as 100%, can be confirmed, for example, by observation with a scanning electron microscope (SEM).

When the liquid A contains no conductive agent, the film formed by the step (ii) will contain no conductive agent. In this case, the electrode material is formed such that the thickness of the organic film 2 corresponds to about one molecule of the constituent molecules of the film. Next, an active material layer is formed by applying a slurry containing this electrode material, a conductive agent and a binder onto both sides of a current collector and then dried, obtaining an electrode plate. Then, the particles of the conductive agent (e.g., acetylene black) in the active material layer may be embedded in the organic film 2 by rolling the obtained electrode plate. Thus, an organic film 2 containing a conductive agent can be obtained.

The thus obtained positive electrode and negative electrode are wound, for example, in a spiral fashion, with a separator interposed therebetween, forming an electrode assembly. Next, the electrode assembly and a non-aqueous electrolyte are housed in a battery case. The positive electrode and the negative electrode are connected to their respective terminals by leads. Then, the case is sealed by a sealing plate, thereby obtaining a secondary battery.

A secondary battery of the present invention also can be produced by another method. In this case, an electrode plate is produced first, using a common active material powder. Specifically, an active material layer containing either a positive electrode active material or a negative electrode active material is formed on a current collector. The active material layer can be formed by a common method. For example, it can be formed by applying a slurry containing an active material powder onto a current collector, followed by drying and rolling.

Next, the active material layer is impregnated with a liquid A containing a film material having a low affinity to the non-aqueous electrolyte. The impregnation may performed by, for example, spraying or applying the liquid A to the active material layer, or immersing an electrode plate in which the active material layer is formed in the liquid A. Thereafter, an organic film 2 containing the film material can be formed on a portion of the surface of the active material particles by drying the active material layer. A secondary battery can be produced in the same manner as described above, except that the thus obtained electrode plate is used.

Examples of a liquid A capable of forming an organic film 2 with a relatively small thickness include a fluorine-based silane compound/fluorine solvent solution (trademark “KP-801”, manufactured by Shin-Etsu Chemical Co. Ltd.) and a fluorine-based coating agent (trademark “DAIFREE A441”, manufactured by DAIKIN INDUSTRIES, LTD.).

An organic film 2 having a larger thickness can be formed by using a liquid obtained by mixing acetylene black in these liquids such that the weight ratio of acetylene black after drying is, for example, 30 wt %.

An organic film 2 having a relatively large thickness can be formed by using a polybutadiene/xylene solution, a pitch/toluene solution, a perfluoroalkyl ester of polyacrylic acid (trademark “UNIDYNE”, manufactured by DAIKIN INDUSTRIES, LTD.) or the like.

(4) Example Using Organic Film of the Present Invention as Underlayer

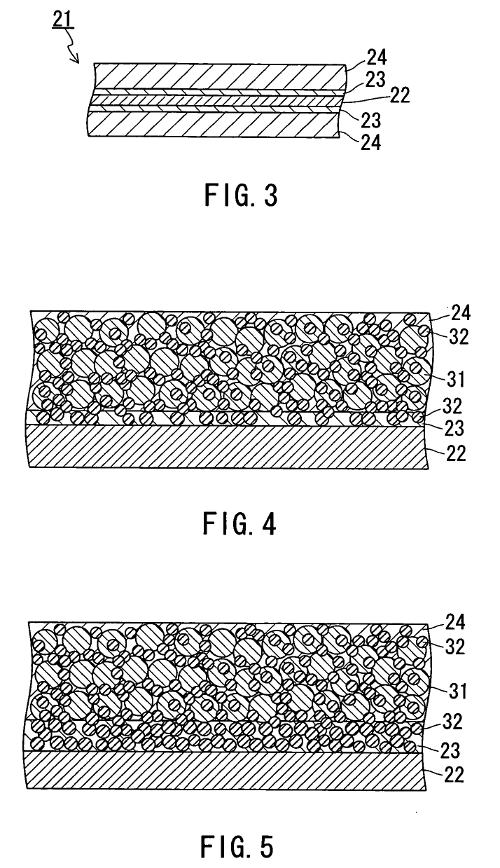

In the secondary battery 10 shown in FIG. 2, at least one electrode selected from the positive electrode 11 and the negative electrode 13 contains a current collector, an underlayer formed on the surface of the current collector and an active material layer that is formed on the underlayer and is electrically connected to the current collector. FIG. 3 schematically shows an example of a cross-sectional view of an electrode plate 21 including the underlayer.

The electrode plate 21 contains a current collector 22, an underlayer 23 formed on both sides of the current collector 22 and an active material layer 24 formed on the underlayer 23. The active material layer 24 is electrically connected to the current collector 22, i.e., it is in a state in which current flows easily. The underlayer 23 is formed on only the positive electrode or the negative electrode, or on both of the positive electrode and the negative electrode. Since the swelling and contraction of the active material layer with charge/discharge generally is larger in the negative electrode, a greater effect of the underlayer 23 tends to be achieved in the negative electrode in view of the fact that the active material layer is separated from the current collector easily. However, depending on the configuration, a greater effect of the underlayer 23 also tends to be achieved in the positive electrode since the positive electrode, which inherently has a lower conductivity, is affected more by the increase in the resistance when the separation occurs. Alternatively, the underlayer 23 and the active material layer 24 may be formed on only one side of the current collector 22.

When the electrode plate 21 is a positive electrode in, for example, a lithium secondary battery, aluminum foil, for example, is used as the current collector 22, and the active material layer 24 contains a positive electrode active material powder. Alternatively, when the electrode plate 21 is a negative electrode, for example, copper foil is used as the current collector 22, and the active material layer 24 contains a negative electrode active material powder. The current collector also may be processed foil. As the positive electrode active material, it is possible to use, for example, a lithium-containing composite oxide. Specific examples include LiCoO₂, LiNiO₂, LiMnO₂ and LiMn₂O₄. As the negative electrode active material, it is possible to use, for example, a metallic material, a carbon material, a conductive polymer material, metallic lithium or a lithium alloy, each of which can be doped or intercalated with lithium ions.

The active material layer 24 further may contain, as necessary, an additive such as a conductive agent and a binder. As the conductive agent, it is possible to use a conductive powder, and examples include acetylene black, carbon black and graphite powder. As the binder, it is possible to use a compound capable of binding the substances in the layer. Examples include rubber-based binders such as hydrogenated nitrile butadiene rubber (HNBR), hydrogenated styrene butadiene rubber (HSBR), polyvinyl alcohol (PVA), polyethylene (PE), styrene butadiene rubber (SBR) and nitrile butadiene rubber (NBR). It is also possible to use fluorocarbon resin-based binders such as polyvinylidene fluoride (PVDF), polytetrafluoroethylene (PTFE) and polytrifluoroethylene (PTrFE). At least one selected from this group is used as the binder. Preferably, the active material layer 24 contains the binder in the range from 2 to 10 parts by weight per 100 parts by weight of the active material.

As the non-aqueous electrolyte encapsulated in the battery case 18, it is possible to use an electrolyte commonly used for non-aqueous electrolyte secondary batteries. Specifically, an electrolyte obtained by dissolving a lithium salt in a non-aqueous solvent may be used. Examples of the non-aqueous solvent include a mixed solvent containing propylene carbonate, ethylene carbonate or the like and dimethyl carbonate, methyl ethyl carbonate, diethyl carbonate, γ-butyrolactone, 1,2-dimethoxyethane, 1,2-diethoxyethane, ethoxymethoxyethane or the like. Examples of the lithium salt include LiPF₆, LiBF₄, LiClO₄, LiAsF₆ and LiCF₃SO₃.

In the following, the underlayer 23 is described. The underlayer 23 contains a film material (hereinafter, occasionally referred to as “film material A”) having a low affinity (i.e., low wettability) with a non-aqueous electrolyte. Preferably, the contact angle formed by a film formed from the film material A having a low affinity to a non-aqueous electrolyte and the non-aqueous electrolyte is at least 40° (more preferably at least 45°, and most preferably at least 60°. The content of the film material A in the underlayer 23 may be any value as long as the underlayer 23 can exert its property of repelling the non-aqueous electrolyte. For example, the content is at least 5 wt % (preferably at least 30 wt %).

The underlayer 23 containing the film material A is a layer having poor wettability with the non-aqueous electrolyte, and the contact angle formed by the underlayer 23 and the non-aqueous electrolyte is preferably at least 20°, and more preferably at least 30°.

With the use of this underlayer 23, the non-aqueous electrolyte permeating the active material layer 24 is repelled by the underlayer 23 and thus does not wet the underlayer and the current collector. Accordingly, it is possible to prevent the formation of a film on the surface of the underlayer or the current collector. Furthermore, even when the active material layer is partially separated owing to the swelling and contraction of the active material layer with repeated charge/discharge of the battery, the underlayer that is present at or in the vicinity of the separated portion prevents the permeation of the electrolyte into the separated portion. Consequently, it is also possible to prevent the electrolyte from coming into direct contact with the current collector at the separated portion of the active material layer. Therefore, in the battery having such an underlayer, it is possible to prevent the formation of a film, such as an oxide film or a film formed by the decomposition of the electrolyte, on the current collector both in the initial state and during repeated charge/discharge. As a result, it is possible to suppress an increase in internal resistance resulting from the formation of a film, thereby preventing a decrease in capacity resulting from the increase in the internal resistance. Meanwhile, the conductivity between the current collector and the active material layer is ensured with the conductive agent and the like contained in the underlayer.

As the film material A, the film material described in the above section (1) is used.

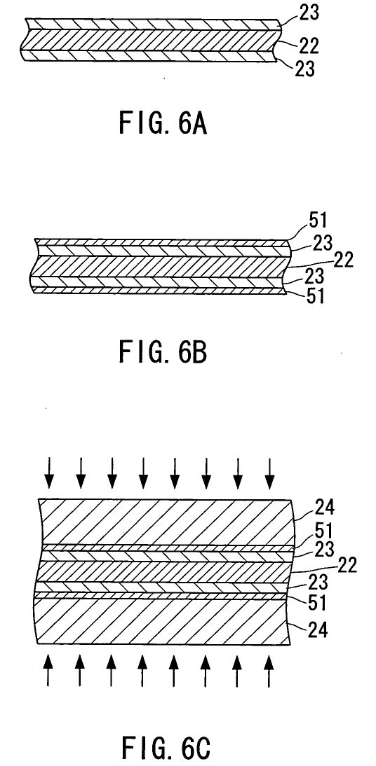

The underlayer 23 may contain a conductive agent and/or a binder. One of the modes in which the underlayer 23 contains a conductive agent includes a case in which the conductive agent penetrates the underlayer 23. FIGS. 4 and 5 schematically show enlarged views of FIG. 3. In FIGS. 4 and 5, only one side of the current collector 22 is shown. In FIG. 4, the underlayer 23 contains a conductive agent 32, and the active material layer 24 contains active material particles 31, a conductive agent 32 and a binder (not shown). In FIG. 5, the underlayer 23 contains a conductive agent 32 and a binder (not shown), and the active material layer 24 contains active material particles 31, a conductive agent 32 and a binder (not shown). The thickness of the underlayer can be made relatively large (e.g., a thickness of 2 μm to 5 μm) by adding a binder to the underlayer 23. Alternatively, the active material layer 24 may be formed on the underlayer 23 with a conductive layer 51 sandwiched between the active material layer 24 and the underlayer 23, as shown in FIG. 6C.

As the conductive agent and the binder that are used in the underlayer 23, the above-described conductive agent and binder may be used. However, the conductive agent and the binder that are contained in the underlayer 23 may be the same as or different from those contained in the active material layer 24. Preferably, the binder contained in the underlayer 23 is a binder having a low affinity (e.g., having a contact angle of at least 40°) for the non-aqueous electrolyte. When the underlayer 23 contains a conductive agent, the ratio of the conductive agent in the underlayer 23 is, for example, 5 wt % to 60 wt %. When the underlayer 23 contains a binder, the ratio of the binder in the underlayer 23 is, for example, 5 wt % to 30 wt %. Although a preferable average particle size of the conductive agent may vary depending on the thickness of the underlayer 23, it is generally about 0.05 μm to about 0.5 μm.

Preferably, the thickness of the underlayer 23 is equal to or larger than the thickness of a monolayer of the film material A, and it is, for example, in the range from 0.01 μm to 5 μm (preferably 0.05 μm to 1 μm). The thickness of the underlayer 23 may be selected based on conditions such as the properties, workability and cost effectiveness of the film material A.

It should be noted that the secondary battery shown in FIG. 2 is one example of the battery of the present invention. There is no particular limitation with respect to the configuration of the battery of the present invention, as long as the above-described underlayer is formed on the surface of the electrode plate (which also applies to the following examples). For example, the battery of the present invention is not limited to cylindrical batteries, and may be prismatic or of other shapes.

(5) Method for Producing Non-Aqueous Electrolyte Secondary Battery Using Underlayer on which Organic Film of the Present Invention is Formed

The method for producing an electrode plate is described with reference to FIG. 3. First, an underlayer 23 containing a film material A having a low affinity to a non-aqueous electrolyte used in the battery is formed on the surface of a current collector 22 of an electrode plate 21 (step (i)). The electrode plate 21 may be a positive electrode and/or a negative electrode. The underlayer 23 can be formed by applying a liquid (hereinafter, occasionally referred to as “liquid A”) containing the film material A onto the surface of the current collector 22, followed by drying. The underlayer 23 also can be formed by immersing the current collector in the liquid A, and subsequently raising and drying the current collector. As the film material A, the one described in the above section (1) is used. Preferably, the contact angle formed by the underlayer 23 and the non-aqueous electrolyte is at least 20° (more preferably at least 30°). The thickness of the underlayer 23 can be adjusted in accordance with the method for forming the underlayer, the types of the film material A and the solvent, and the type and content of the binder.

The solvent or dispersion medium for the liquid A may be any solvent or dispersion medium in which the film material A can be dissolved or dispersed homogeneously, and may be selected in accordance with the film material A. The liquid A may, as necessary, contain additives such as a conductive agent and/or a binder. As these additives, those described in the above section (1) can be used. The content of the film material A in the liquid A is, for example, 0.5 wt % to 10 wt %.

Next, an active material layer 24 electrically connected to the current collector 22 is formed on the underlayer 23 (step (ii)). The active material layer 24 can be formed by a common method. For example, it can be formed by applying a slurry containing an active material powder onto the underlayer 23, followed by drying and rolling. Generally, this slurry contains additives such as a conductive agent and a binder, in addition to the active material powder. Preferably, the rolling is performed with a roller heated at 40° C. to 90° C. The binder contained in the slurry is softened by heating the roller, thereby achieving the following effects. First, the filling density of the active material can be increased easily, and a desired filling density can be achieved with reduced frequency of rolling. Second, the change in the thickness of the electrode plate after rolling can be suppressed. Third, since the softening of the binder increases the area where the binder exerts its effects, it is possible to improve the adhesion between the active material particles and between the underlayer and the positive electrode active material layer, improving the battery characteristics.

The current collector 22 and the active material layer 24 are connected electrically via the conductive agent contained in the underlayer 23. The method for adding a conductive agent to the underlayer 23 is described below.

In the first method, a conductive agent (and, as necessary, a binder) is added to the liquid A. The underlayer 23 is formed by immersing the current collector in the liquid A to which the conductive agent has been added such that the content of the conductive agent (e.g., acetylene black) in the underlayer 23 is, for example, 20 wt %, and subsequently raising and drying the current collector. This makes it possible to form the underlayer 23 to have a thickness corresponding to about one to several molecular layers of the film material A. When the liquid A contains a binder, the underlayer 23 is formed to have a relatively large thickness, for example, 2 μm to 5 μm.

In the second method, the underlayer 23 is formed from a liquid A containing no conductive agent. In this case, it is preferable to form the underlayer 23 to have a small thickness. A thin film of the film material A can be formed by immersing the current collector 22 in the liquid A, followed by raising the current collector. Next, the active material layer 24 is formed by applying a slurry containing a conductive agent and an active material powder onto the underlayer 23, followed by drying. Thereafter, the conductive agent in the active material layer 24 is caused to penetrate the underlayer 23 by applying pressure from the surface toward the inside of the active material layer 24. The current collector 22 and the active material layer 24 are connected electrically by the conductive agent penetrating the underlayer 23. The portion of the underlayer 23 that is not penetrated by the conductive agent protects the current collector 22. At this time, a portion of the underlayer 23 may be broken mechanically, and the current collector 22 and the active material layer 24 may be partially in contact with each other. The pressurization of the active material layer 24 can be performed using, for example, a roll press with a linear load of 9800 N/cm (1000 kgf/cm).

In the third method, the underlayer 23 is formed on the current collector 22, as shown in FIG. 6A. As in the second method, the underlayer 23 preferably has a small thickness.

Next, as shown in FIG. 6B, a conductive layer 51 containing a conductive agent is formed on the underlayer 23. The conductive layer 51 can be formed by, for example, applying a liquid containing only a conductive agent (e.g., acetylene black) onto the underlayer 23, followed by drying. The thickness of the conductive layer 51 is, for example, 0.1 μm to 3 μm.

Next, after forming an active material layer 24 on the conductive layer 51, pressure is applied from the surface towards the inside of the active material layer 24, as shown in FIG. 6C. Consequently, the conductive agent in the conductive layer 51 is caused to penetrate the underlayer 23. The current collector 22 and the active material layer 24 are connected electrically by the conductive agent penetrating the underlayer 23. The method for forming the active material layer 24 and the pressing conditions are the same as those described above. In the pressed electrode plate, the active material layer 24 is formed on the underlayer 23 with the conductive layer 51 interposed between the active material layer 24 and the underlayer 23.

It should be noted that use of a fluorine-based silane compound/fluorine solvent solution (trademark “KP-801”, manufactured by Shin-Etsu Chemical Co. Ltd.), a fluorine-based coating agent (trademark “DAIFREE A441”, manufactured by DAIKIN INDUSTRIES, LTD.) or the like as the liquid A facilitates the formation of an underlayer 23 having a relatively small thickness.

In the case of forming an underlayer having a relatively large thickness, it is possible to form a coating by mixing the film material A and a conductive agent (e.g.,. acetylene black) such that the content of acetylene black after drying is, for example, 30 wt %, and applying this coating onto a current collector in a thickness of about 2 μm to about 5 μm, followed by drying. The use of a polybutadiene/xylene solution, a pitch/toluene solution, a perfluoroalkyl ester of polyacrylic acid (trademark “UNIDYNE”, manufactured by DAIKIN INDUSTRIES, LTD.) or the like as the liquid A facilitates the formation of an underlayer having a relatively large thickness.

Thus, an electrode plate can be produced. When one of the positive electrode and the negative electrode is an electrode plate that has no underlayer, such electrode plate can be produced by a common method. In this case, a slurry containing an active material powder and the like may be applied onto a current collector, followed by drying and pressing.

A non-aqueous electrolyte secondary battery is produced using the thus obtained electrode plate. Except for the method for producing the electrode plate 21, any known method can be used for producing the battery without any particular limitation. Generally, a positive electrode and a negative electrode are wound or laminated with a separator interposed therebetween, forming an electrode assembly. Then, the electrode assembly and a non-aqueous electrolyte are encapsulated in a battery case, which is then sealed by a sealing plate. Thus, a secondary battery described in the above section (4) can be produced.

Although each embodiment of the present invention has been described above by way of examples, the invention is not limited to the above-described embodiments and can be applied to any embodiment in accordance with the technical idea of the invention. For example, the battery of the present invention is not limited to cylindrical batteries, and may be prismatic or of other shapes.

According to the present invention, it is possible to minimize electrolyte from coming into direct contact with a current collector even during repeated charge/discharge. Therefore, it is possible to suppress the formation of a film resulting from the contact between the electrolyte and the surface of the current collector. Consequently, it is possible to suppress an increase in internal resistance of the battery with repeated charge/discharge cycles and a decrease in discharge capacity resulting from such increase. Thus, the present invention can provide a non-aqueous electrolyte secondary battery that exhibits a small decrease in capacity due to repeated charge/discharge cycles.

### EXAMPLES

Hereinafter, the present invention will be described more specifically by way of examples.

### Example 1

Evaluation of Films

First, the affinity to a non-aqueous electrolyte was examined for six types of films. Specifically, first, films were formed by applying liquids containing film materials onto substrates, followed by drying. Next, a non-aqueous electrolyte was added dropped onto the films, and the contact angle formed between each film and the non-aqueous electrolyte was measured. As the substrate, a substrate (ceramics substrate) made of a sintered oxide and a glass substrate on which carbon was deposited were used. As the non-aqueous electrolyte, a non-aqueous electrolyte in which LiPF₆ is dissolved at a concentration of 1 M in a mixed solvent of ethylene carbonate and methyl ethyl carbonate with a volume ratio of 1:2 was used. As the liquids containing the film materials, the following were used:
(1) fluorine-based silane compound/fluorine solvent solution (KP-801, manufactured by Shin-Etsu Chemical Co. Ltd.);
(2) fluorine-based surface treating agent/fluorine solvent solution (KY-8, manufactured by Shin-Etsu Chemical Co. Ltd);
(3) alkoxysilane/propanol solution (Biowater guard M, manufactured by Shin-Etsu Chemical Co. Ltd);
(4) fluorine-based coating agent (DAIFREE A441, manufactured by DAIKIN INDUSTRIES, LTD.);
(5) polybutadiene/xylene solution; and
(6) pitch/toluene solution.

In the following, reference numerals (1) to (6) occasionally may be used to denote these films or liquids. The results of the measurement are shown in TABLE 1.

TABLE 1

liquid used and contact angle

| | (1) | (2) | (3) | (4) | (5) | (6) |
|---|---|---|---|---|---|---|
| ceramics | 58° | 32° | 28° | 50° | 45° | 50° |
| carbon deposited | 55° | 33° | 30° | 51° | 44° | 49° |

As can be seen from the results of TABLE 1, the fluorine-based organic films do not necessarily have a large contact angle, and may have a smaller contact angle as in the case of the fluorine-based surface treating agent. Additionally, little difference was observed in the contact angles for the different underlayers. It can be seen from this that similar contact angles can be obtained when these organic films are formed on the surface of the active material particles.

Next, various electrode plates were produced using the above-described liquids (1) to (6), as described below. Then, cylindrical non-aqueous electrolyte secondary batteries as shown in FIG. 2 (capacity: about 800 mAh, size: ICR17500 prescribed in JIS-C8711) were produced using the electrode plates, and their characteristics were evaluated.

Sample 1

Here, a positive electrode material of the present invention was formed, and a secondary battery (sample 1) was produced using the positive electrode material.

A positive electrode was produced as follows. First, acetylene black was dispersed in (1) fluorine-based silane compound/fluorine solvent solution such that the weight ratio of acetylene black after drying was 20 wt %. This dispersion was sprayed to a lithium cobaltate (LiCoO₂) powder serving as an active material such that the ratio of the organic film (1) to the active material was 0.05 wt % to 3 wt % and then dried. Thus, a film was formed on a portion (50% to 80%) of the surface of the active material particles. The thickness of this film after drying approximately corresponded to a layer of several molecules of the constituent molecules of the film material.

The resulting electrode material was used as the positive electrode active material of a lithium secondary battery. This electrode material, acetylene black as a conductive agent, a fluorine-based binder (e.g., PVDF) as a binder and a dispersion medium were mixed, producing a positive electrode slurry. This slurry was applied onto both sides of aluminum foil serving as the core, then dried and rolled. Thus, a positive electrode plate in which an active material layer was formed was obtained.

Meanwhile, in the production of a negative electrode, a carbon-based material obtained by sintering an organic film compound, a rubber-based binder, acetylene black as a conductive agent and a dispersion medium were mixed first, producing a negative electrode slurry. This slurry was applied onto both sides of copper foil serving as the core, then dried and rolled. Thus, a negative electrode in which an active material layer was formed was obtained.

As the separator, a porous film made of polyethylene was used. Then, the positive electrode plate and the negative electrode plate were wound in such a manner that the separator was disposed therebetween, thereby producing a spiral electrode assembly.

Next, the positive electrode plate was connected to a positive electrode cover by a positive electrode lead, and the negative electrode plate was connected to a battery case by a negative electrode lead. At this time, an insulating plate was disposed on both ends of the electrode assembly. Then, after injecting a non-aqueous electrolyte into the battery case, the battery case was sealed by the positive electrode cover. Thereafter, the initial charge of this battery was performed at a predetermined voltage. Thus, a lithium secondary battery (sample 1) was produced.

Sample 2

A film was formed on a portion of the surface of positive electrode active material particles using a film material different from that of sample 1, and sample 2 was produced using the resulting positive electrode material.

First, acetylene black was dispersed in (2) fluorine-based surface treating agent/fluorine solvent solution such that the weight ratio of acetylene black after drying was 20 wt %. This dispersion was sprayed to a lithium cobaltate (LiCoO₂) powder serving as an active material such that the ratio of the film material to the active material was 0.05 wt % to 3 wt % and then dried. Thus, a film was formed on 50% to 80% of the surface of the active material particles, obtaining a positive electrode material. The thickness of this film after drying approximately corresponded to a layer of several molecules of the constituent molecules of the film material.

A secondary battery (sample 2) was produced in the same manner as in sample 1, except that the thus obtained positive electrode material was used.

Sample 3

A film was formed on a portion of the surface of positive electrode active material particles using a film material different from that of sample 1, and sample 3 was produced using the resulting positive electrode material.

First, acetylene black was dispersed in (3) alkoxysilane/propanol solution such that the weight ratio of acetylene black after drying was 20 wt %. This dispersion was sprayed to a lithium cobaltate (LiCoO₂) powder serving as an active material such that the ratio of the film material to the active material was 0.05 wt % to 3 wt % and then dried. Thus, a film was formed on 50% to 80% of the surface of the active material particles, obtaining a positive electrode material. The thickness of this film after drying approximately corresponded to a layer of several molecules of the constituent molecules of the film material.

A secondary battery (sample 3) was produced in the same manner as in sample 1, except that the thus obtained positive electrode material was used.

Sample 4

A film was formed on a portion of the surface of positive electrode active material particles using a film material different from that of sample 1, and sample 4 was produced using the resulting positive electrode material.

First, acetylene black was dispersed in (4) fluorine-based coating agent such that the weight ratio of acetylene black after drying was 20 wt %. This dispersion was sprayed to a lithium cobaltate (LiCoO₂) powder serving as an active material such that the ratio of the film material to the active material was 0.05 wt % to 3 wt % and then dried. Thus, a film was formed on 50% to 80% of the surface of the active material particles, obtaining a positive electrode material. The thickness of this film after drying approximately corresponded to a layer of several molecules of the constituent molecules of the film material.

A secondary battery (sample 4) was produced in the same manner as in sample 1, except that the thus obtained positive electrode material was used.

Sample 5

A film was formed on a portion of the surface of positive electrode active material particles using a film material different from that of sample 1, and sample 5 was produced using the resulting positive electrode material.

First, acetylene black was dispersed in (5) polybutadiene/xylene solution such that the weight ratio of acetylene black after drying was 30 wt %. This dispersion was sprayed to a lithium cobaltate (LiCoO₂) powder serving as an active material such that the ratio of the film material to the active material was 0.05 wt % to 3 wt % and then dried. Thus, a film was formed on 50% to 80% of the surface of the active material particles, obtaining a positive electrode material.

A secondary battery (sample 5) was produced in the same manner as in sample 1, except that the thus obtained positive electrode material was used.

Sample 6

A film was formed on a portion of the surface of positive electrode active material particles using a film material different from that of sample 1, and sample 6 was produced using the resulting positive electrode material.

First, acetylene black was dispersed in (6) pitch/toluene solution such that the weight ratio of acetylene black after drying was 30 wt %. This dispersion was sprayed to a lithium cobaltate (LiCoO₂) powder serving as an active material such that the ratio of the film material to the active material was 0.05 wt % to 3 wt % and then dried. Thus, a film was formed on 50% to 80% of the surface of the active material particles, obtaining a positive electrode material.

A secondary battery (sample 6) was produced in the same manner as in sample 1, except that the thus obtained positive electrode material was used.

Sample 7

Here, a negative electrode material of the present invention was formed, and a secondary battery (sample 7) was produced using the negative electrode material.

A positive electrode was produced as follows. First, a lithium cobaltate (LiCoO₂) powder serving as a positive electrode active material, acetylene black as a conductive agent, a fluorine-based binder (e.g., PVDF) as a binder and a dispersion medium were mixed, producing a slurry. This slurry was applied onto both sides of aluminum foil serving as a positive electrode current collector, then dried and rolled. Thus, a positive electrode plate in which an active material layer was formed was obtained.

A negative electrode was produced as follows. First, acetylene black was dispersed in (1) fluorine-based silane compound/fluorine solvent solution such that the weight ratio of acetylene black after drying was 15 wt %. This dispersion was sprayed to a mesophase pitch-based carbon fiber powder (having an average fiber diameter of 7 μm and an average fiber length of 18 μm) serving as a negative electrode active material such that the ratio of the film material (1) to the active material was 0.1 wt % to 10 wt % and then dried. Thus, a film was formed on 50% to 80% of the surface of the negative electrode active material particles. The thickness of this film after drying approximately corresponded to a layer of several molecules of the constituent molecules of the film material.

The thus obtained negative electrode material, a rubber-based binder, acetylene black as a conductive agent and a dispersion medium were mixed, producing a negative electrode slurry. This negative electrode slurry was applied onto both sides of copper foil serving as the core, then dried and rolled. Thus, a negative electrode in which an active material layer was formed was obtained.

A secondary battery (sample 7) was produced in the same manner as in sample 1, except that the thus obtained positive electrode and negative electrode were used.

Sample 8

A film was formed on a portion of the surface of negative electrode active material particles using a film material different from that of sample 7, and sample 8 was produced using the resulting negative electrode material.

First, acetylene black was dispersed in (2) fluorine-based surface treating agent/fluorine solvent solution such that the weight ratio of acetylene black after drying was 15 wt %. This dispersion was sprayed to a mesophase pitch-based carbon fiber powder (having an average fiber diameter of 7 μm and an average fiber length of 18 μm) serving as a negative electrode active material such that the ratio of the film material to the active material was 0.1 wt % to 10 wt % and then dried. Thus, a film was formed on 50% to 80% of the surface of the negative electrode active material particles. The thickness of this film after drying approximately corresponded to a layer of several molecules of the constituent molecules of the film material.

A secondary battery (sample 8) was produced in the same manner as in sample 7, except that the thus obtained negative electrode material was used.

Sample 9

A film was formed on a portion of the surface of negative electrode active material particles using a film material different from that of sample 7, and sample 9 was produced using the resulting negative electrode material.

First, acetylene black was dispersed in (3) alkoxysilane/propanol solution such that the weight ratio of acetylene black after drying was 15 wt %. This dispersion was sprayed to a mesophase pitch-based carbon fiber powder (having an average fiber diameter of 7 μm and an average fiber length of 18 μm) serving as a negative electrode active material such that the ratio of the film material to the active material was 0.1 wt % to 10 wt % and then dried. Thus, a film was formed on 50% to 80% of the surface of the negative electrode active material particles. The thickness of this film after drying approximately corresponded to a layer of several molecules of the constituent molecules of the film material.

A secondary battery (sample 9) was produced in the same manner as in sample 7, except that the thus obtained negative electrode material was used.

Sample 10

A film was formed on a portion of the surface of negative electrode active material particles using a film material different from that of sample 7, and sample 10 was produced using the resulting negative electrode material.

First, acetylene black was dispersed in (4) fluorine-based coating agent such that the weight ratio of acetylene black after drying was 15 wt %. This dispersion was sprayed to a mesophase pitch-based carbon fiber powder (having an average fiber diameter of 7 μm and an average fiber length of 18 μm) serving as a negative electrode active material such that the ratio of the film material to the active material was 0.1 wt % to 10 wt % and then dried. Thus, a film was formed on 50% to 80% of the surface of the negative electrode active material particles. The thickness of this film after drying approximately corresponded to a layer of several molecules of the constituent molecules of the film material.

A secondary battery (sample 10) was produced in the same manner as in sample 7, except that the thus obtained negative electrode material was used.

Sample 11

A film was formed on a portion of the surface of negative electrode active material particles using a film material different from that of sample 7, and sample 11 was produced using the resulting negative electrode material.

First, acetylene black was dispersed in (5) polybutadiene/xylene solution such that the weight ratio of acetylene black after drying was 20 wt %. This dispersion was sprayed to a mesophase pitch-based carbon fiber powder (having an average fiber diameter of 7 μm and an average fiber length of 18 μm) serving as a negative electrode active material such that the ratio of the film material to the active material was 0.1 wt % to 10 wt % and then dried. Thus, a film was formed on 50% to 80% of the surface of the negative electrode active material particles.

A secondary battery (sample 11) was produced in the same manner as in sample 7, except that the thus obtained negative electrode material was used.

Sample 12

A film was formed on a portion of the surface of negative electrode active material particles using a film material different from that of sample 7, and sample 12 was produced using the resulting negative electrode material.

First, acetylene black was dispersed in (6) pitch/toluene solution such that the weight ratio of acetylene black after drying was 20 wt %. This dispersion was sprayed to a mesophase pitch-based carbon fiber powder (having an average fiber diameter of 7 μm and an average fiber length of 18 μm) serving as a negative electrode active material such that the ratio of the film material to the active material was 0.1 wt % to 10 wt % and then dried. Thus, a film was formed on 50% to 80% of the surface of the negative electrode active material particles.

A secondary battery (sample 12) was produced in the same manner as in sample 7, except that the thus obtained negative electrode material was used.

Sample 13

Sample 13 was produced in the same manner as in sample 1, except that the positive electrode of sample 1 and the negative electrode of sample 7 were used.

Sample 14

Sample 14 was produced in the same manner as in sample 1, except that the positive electrode of sample 4 and the negative electrode of sample 10 were used.

Sample 15

Sample 15 was produced in the same manner as in sample 1, except that the positive electrode of sample 5 and the negative electrode of sample 11 were used.

Sample 16

Sample 16 was produced in the same manner as in sample 1, except that the positive electrode of sample 6 and the negative electrode of sample 12 were used.

Sample 17

In sample 17, a film was formed on a portion of the surfaces of positive electrode active material particles and negative electrode active material particles.

A positive electrode was produced as follows. First, (1) fluorine-based silane compound/fluorine solvent solution was sprayed to a lithium cobaltate (LiCoO₂) powder serving as a positive electrode active material such that the ratio of the film material to the active material was 0.05 wt % to 3 wt % and then dried. Thus, a positive electrode material in which a film was formed on 50% to 80% of the surface of the active material particles was produced. This positive electrode material, acetylene black as a conductive agent, a fluorine-based binder (e.g., PVDF) as a binder and a dispersion medium were mixed, producing a slurry. This slurry was applied onto both sides of aluminum foil serving as a positive electrode current collector, then dried and subsequently rolled. Thus, a positive electrode plate in which an active material layer was formed was obtained.

A negative electrode was produced as follows. First, (1) fluorine-based silane compound/fluorine solvent solution was sprayed to a mesophase pitch-based carbon fiber powder (having an average fiber diameter of 7 μm and an average fiber length of 18 μm) serving as a negative electrode active material and then dried. Thus, a negative electrode material in which a film was formed on 50% to 80% of the surface of the active material particles was produced. This negative electrode material, a rubber-based binder, acetylene black as a conductive agent and a dispersion medium were mixed, producing a slurry. This slurry was applied onto both sides of copper foil serving as the core, then dried and subsequently rolled. Thus, a negative electrode in which an active material layer was formed was obtained.

A secondary battery (sample 17) was produced in the same manner as in sample 1, except that the thus obtained positive electrode and negative electrode were used.

Sample 18

In sample 18, a film was formed on a portion of the surfaces of positive electrode active material particles and negative electrode active material particles.

A positive electrode was produced as follows. First, (1) fluorine-based silane compound/fluorine solvent solution was sprayed to a lithium cobaltate (LiCoO₂) powder serving as a positive electrode active material such that the ratio of the film material to the active material was 0.05 wt % to 3 wt % and then dried. Thus, a film was formed on 50% to 80% of the surface of the active material particles. Next, a positive electrode material in which acetylene black was dispersed on the surface of the film was produced by mixing this active material powder and acetylene black. This positive electrode material, a fluorine-based binder (e.g., PVDF) as a binder and a dispersion medium were mixed, producing a slurry. This slurry was applied onto both sides of aluminum foil serving as a positive electrode current collector, then dried and subsequently rolled. Thus, a positive electrode plate in which an active material layer was formed was obtained.

A negative electrode was produced as follows. First, (1) fluorine-based silane compound/fluorine solvent solution was sprayed to a mesophase pitch-based carbon fiber powder (having an average fiber diameter of 7 μm and an average fiber length of 18 μm) serving as a negative electrode active material and then dried. Thus, a film was formed on 50% to 80% of the surface of the negative electrode active material particles. Next, a negative electrode material in which acetylene black was dispersed on the surface of the film was produced by mixing this active material powder and acetylene black. This negative electrode material, a rubber-based binder and a dispersion medium were mixed, producing a slurry. This slurry was applied onto both sides of copper foil serving as the core, then dried and subsequently rolled. Thus, a negative electrode in which an active material layer was formed was obtained.

A secondary battery (sample 18) was produced in the same manner as in sample 1, except that the thus obtained positive electrode and negative electrode were used.

Sample 19

In sample 19, a film was formed on a portion of the surface of positive electrode active material particles.

First, a dispersion was prepared by mixing (1) fluorine-based silane compound/fluorine solvent solution, acetylene black and polyvinylidene (PVDF)/N-methyl-2-pyrrolidone (NMP). This dispersion was prepared such that the weight ratio of the film material to the active material after drying was 0.05 wt % to 3 wt % and the weight ratio of acetylene black to the binder was 2:1. This dispersion was sprayed to a lithium cobaltate (LiCoO₂) powder serving as a positive electrode active material and then dried. Thus, a positive electrode material in which a film was formed on 50% to 80% of the surface of the active material particles was produced. A secondary battery (sample 19) was produced in the same manner as in sample 1, except that this positive electrode material was used.

Sample 20

In sample 20, a film was formed on a portion of the surface of positive electrode active material particles.

First, a dispersion was prepared by mixing (6) pitch/toluene solution, acetylene black and polyvinylidene fluoride (PVDF)/N-methyl-2-pyrrolidone (NMP). The dispersion was prepared such that the weight ratio of the film material to the active material after drying was 0.05 wt % to 3 wt % and the weight ratio of acetylene black to the binder was 2:1. This dispersion was sprayed to a lithium cobaltate (LiCoO₂) powder serving as a positive electrode active material and then dried. Thus, a positive electrode material in which a film was formed on 50% to 80% of the surface of the active material particles was produced. A secondary battery (sample 20) was produced in the same manner as in sample 1, except that this positive electrode material was used.

Sample 21

In sample 21, a film was formed on a portion of the surface of negative electrode active material particles.

First, a dispersion was prepared by mixing (1) fluorine-based silane compound/fluorine solvent solution, acetylene black and polyvinylidene fluoride (PVDF)/N-methyl-2-pyrrolidone (NMP). The dispersion was prepared such that the ratio of the film material to the active material after drying was 0.1 wt % to 10 wt % and the weight ratio of acetylene black to the binder was 2:1. This dispersion was sprayed to a mesophase pitch-based carbon fiber powder (having an average fiber diameter of 7 μm and an average fiber length of 18 μm) serving as a negative electrode active material and then dried. Thus, a negative electrode material in which a film was formed on 50% to 80% of the surface of the active material particles was produced. A secondary battery (sample 21) was produced in the same manner as in sample 7, except that this negative electrode material was used.

Sample 22

In sample 22, a film was formed on a portion of the surface of negative electrode active material particles.

First, a dispersion was prepared by mixing (6) pitch/toluene solution, acetylene black and polyvinylidene fluoride (PVDF)/N-methyl-2-pyrrolidone (NMP). The dispersion was prepared such that the ratio of the film material to the active material after drying was 0.1 wt % to 10 wt % and the weight ratio of acetylene black to the binder was 2:1. This dispersion was sprayed to a mesophase pitch-based carbon fiber powder (having an average fiber diameter of 7 μm and an average fiber length of 18 μm) serving as a negative electrode active material and then dried. Thus, a negative electrode material in which a film was formed on 50% to 80% of the surface of the active material particles was produced. A secondary battery (sample 22) was produced in the same manner as in sample 7, except that this negative electrode material was used.

Sample 23

Sample 23 was produced in the same manner as in sample 1, except that the positive electrode of sample 17 and the negative electrode of sample 21 were used.

Sample 24

Sample 24 was produced in the same manner as in sample 1, except that the positive electrode of sample 18 and the negative electrode of sample 22 were used.

Sample 25

In sample 25, a positive electrode was produced by immersing a positive electrode active material layer in a liquid containing a film material.

First, a lithium cobaltate (LiCoO₂) powder serving as an active material, acetylene black as a conductive agent, a fluorine-based binder (e.g., PVDF) as a binder and a dispersion medium were mixed, producing a slurry. This slurry was applied onto both sides of aluminum foil serving as the core, then dried and rolled. Thus, a positive electrode plate in which an active material layer was formed on the surface was obtained. Meanwhile, a dispersion was prepared by dispersing acetylene black in (6) pitch/toluene solution such that the weight ratio of acetylene black after drying was 30 wt %. The positive electrode plate was immersed in this dispersion, in which the ratio of the film material was 3 wt % to 5 wt %, using an amount of the dispersion just enough to immerse the positive electrode plate, thereby causing the dispersion to permeate to the inside of the active material layer. Thereafter, the positive electrode plate was dried. Thus, a positive electrode in which a film was formed on 10% to 50% of the surface of the active material particles was produced. A secondary battery (sample 25) was produced in the same manner as in sample 1, except that this positive electrode was used.

Sample 26

In sample 26, a negative electrode was produced by immersing a negative electrode active material layer in a liquid containing a film material.

A positive electrode was produced as follows. First, a lithium cobaltate (LiCoO₂) powder serving as a positive electrode active material, acetylene black as a conductive agent, a fluorine-based binder (e.g., PVDF) as a binder and a dispersion medium were mixed, producing a slurry. This slurry was applied onto both sides of aluminum foil serving as a current collector, then dried and rolled. Thus, a positive electrode plate in which an active material layer was formed on the surface was obtained.

A negative electrode was produced as follows. A mesophase pitch-based carbon fiber powder (having an average fiber diameter of 7 μm and an average fiber length of 18 μm) serving as a negative electrode active material, a rubber-based binder, acetylene black as a conductive agent and a dispersion medium were mixed, producing a slurry. This slurry was applied onto both sides of copper foil serving as a current collector, then dried and rolled. Thus, a negative electrode in which an active material layer was formed on the surface was obtained. Meanwhile, a dispersion was prepared by dispersing acetylene black in (6) pitch/toluene solution such that the weight ratio of acetylene black after drying was 30 wt %. The negative electrode plate was immersed in this dispersion, in which the ratio of the film material was 3 wt % to 5 wt %, using an amount of the dispersion just enough to immerse the negative electrode plate, thereby causing the dispersion to permeate to the inside of the active material layer. Thereafter, the negative electrode plate was dried. Thus, a negative electrode in which a film was formed on 10% to 50% of the surface of the negative electrode active material particles was produced. A secondary battery (sample 26) was produced in the same manner as in sample 7, except that this negative electrode was used.

Sample 27

A secondary battery (sample 27) was produced in the same manner as in sample 1, except that the positive electrode of sample 25 and the negative electrode of sample 26 were used.

Sample 28

In sample 28, a film was formed on a portion of the surfaces of positive electrode active material particles and negative electrode active material particles.

A positive electrode was produced as follows. First, acetylene black was dispersed in (1) fluorine-based silane compound/fluorine solvent solution such that the weight ratio of acetylene black after drying was 20 wt %. A lithium cobaltate (LiCoO₂) powder serving as a positive electrode active material was immersed in this dispersion, in which the ratio of the film material was 10% to 15% and then dried. Thus, a film was formed on 90% to 100% of the surface of the active material particles. Similarly, a mesophase pitch-based carbon fiber powder (having an average fiber diameter of 7 μm and an average fiber length of 18 μm) serving as a negative electrode active material was immersed in the above-described dispersion and then dried. Thus, a film was formed on 90% to 100% of the surface of the active material particles. A secondary battery (sample 28) was produced in the same manner as in sample 1, except that these electrode materials were used.

Sample 29

Sample 29 is a comparative example, in which conventional electrode materials were used. A secondary battery (sample 29) was produced in the same manner as in sample 1, except that the film containing the film material and acetylene black was not formed on the lithium cobaltate (LiCoO₂) powder serving as the active material.

Evaluation of Battery Characteristics

The 29 types of samples thus produced were subjected to 500 repeated charge/discharge cycles at a current of 800 mA and a temperature of 20° C. Thereafter, the discharge capacity was measured until the battery voltage dropped from 4.2 V to 3.0 V at predetermined cycle numbers. Then, the cycle characteristics of each sample were evaluated from the change in this discharge capacity. The results of the measurement are shown in TABLE 2. The liquids used for forming the films also are shown in TABLE

TABLE 2

| | liquid used | | elapsed cycle number and discharge capacity (mAh) | | | | |
|---|---|---|---|---|---|---|---|
| | positive | negative | | | | 200 | 500 |
| | electrode | electrode | 1 cycle | 10 cycles | 50 cycles | cycles | cycles |
| sample 1 | (1) | none | 805.3 | 796.9 | 764.9 | 708.4 | 568.9 |
| sample 2 | (2) | none | 802.2 | 793.8 | 762.7 | 617.8 | 316.0 |
| sample 3 | (3) | none | 804.4 | 794.7 | 763.6 | 615.6 | 310.2 |
| sample 4 | (4) | none | 800.4 | 791.6 | 763.6 | 695.6 | 546.7 |
| sample 5 | (5) | none | 803.6 | 793.3 | 764.9 | 693.3 | 524.4 |
| sample 6 | (6) | none | 802.7 | 792.0 | 763.6 | 693.8 | 537.8 |
| sample 7 | none | (1) | 804.4 | 793.3 | 762.2 | 694.2 | 543.1 |
| sample 8 | none | (2) | 802.2 | 792.4 | 760.9 | 611.1 | 312.0 |
| sample 9 | none | (3) | 801.3 | 792.9 | 761.3 | 610.2 | 306.7 |
| sample 10 | none | (4) | 803.6 | 792.4 | 761.8 | 691.1 | 540.0 |
| sample 11 | none | (5) | 800.9 | 791.1 | 760.9 | 688.0 | 533.8 |
| sample 12 | none | (6) | 804.9 | 570.7 | 762.2 | 689.8 | 541.3 |
| sample 13 | (1) | (1) | 802.2 | 795.6 | 771.6 | 715.6 | 606.7 |
| sample 14 | (4) | (4) | 805.3 | 797.3 | 773.3 | 716.4 | 604.0 |
| sample 15 | (5) | (5) | 801.3 | 792.9 | 760.9 | 700.4 | 583.1 |
| sample 16 | (6) | (6) | 800.4 | 791.1 | 768.9 | 702.2 | 592.0 |
| sample 17 | (1) | (1) | 801.5 | 793.4 | 769.1 | 711.1 | 602.3 |
| sample 18 | (1) | (1) | 800.9 | 793.0 | 770.2 | 710.5 | 599.7 |
| sample 19 | (1) | none | 805.3 | 796.9 | 764.9 | 708.4 | 568.9 |
| sample 20 | (6) | none | 802.2 | 793.8 | 762.7 | 706.7 | 567.6 |
| sample 21 | none | (1) | 804.4 | 796.0 | 760.9 | 695.6 | 547.6 |
| sample 22 | none | (6) | 800.4 | 793.3 | 761.3 | 692.4 | 544.0 |
| sample 23 | (1) | (1) | 805.3 | 797.8 | 771.1 | 716.4 | 605.3 |
| sample 24 | (6) | (6) | 802.7 | 796.4 | 766.7 | 710.2 | 590.2 |
| sample 25 | (6) | none | 800.4 | 795.3 | 765.3 | 702.3 | 581.9 |
| sample 26 | none | (6) | 805.3 | 799.8 | 778.1 | 719.5 | 612.0 |
| sample 27 | (6) | (6) | 802.7 | 799.4 | 769.7 | 712.1 | 595.8 |
| sample 28 | (1) | (1) | 412.5 | 399.4 | 382.2 | 358.1 | 324.5 |
| sample 29 | none | none | 804.4 | 793.3 | 761.8 | 609.3 | 304.9 |

As can be seen from TABLE 2, the values of the discharge capacity up to 50 cycles in samples 1 to 16 were substantially the same, and there was little difference between these values and the value of sample 29 of the comparative example. However, a difference occurred in the degree of decrease in discharge capacity after 200 cycles, and this difference became significant at 500 cycles. This is due to the difference in the materials of the films formed on the surface of the active material particles.

Particularly, when the films were formed using (1) fluorine-based silane compound/fluorine solvent solution (trademark “KP-801”, manufactured by Shin-Etsu Chemical Co. Ltd.), (4) fluorine-based coating agent (trademark “DAIFREE A441”, manufactured by DAIKIN INDUSTRIES, LTD.), (5) polybutadiene/xylene solution and (6) pitch/toluene solution, the decrease in discharge capacity was improved significantly. In addition, the results of TABLE 1 show that the contact angle formed by each of the films formed by these film materials and the non-aqueous electrolyte was more than 40°, indicating that the use of the films having a large contact angle, i.e., a low wettability with the non-aqueous electrolyte significantly can improve the cycle life of the batteries. However, sample 28, in which the film was formed on substantially the entire surface of the active material particles, had a smaller discharge capacity than other samples from the beginning. Presumably, this is because the film formed on the entire surface of the active material particles prevented the electrolyte from reaching the active material, inhibiting the battery reaction. This indicates that it is important that the area where the polymer film is formed be less than 90% of the surface of the active material particles.

In the case of (2) fluorine-based surface treating agent, which was used for samples 2 and 8, the contact angle was relatively small as shown in TABLE 1, and the cycle characteristics of the batteries were hardly improved by using this liquid. In the case of (3) alkoxysilane, which was used for samples 3 and 9, the cycle characteristics were hardly improved. On the other hand, the results of samples 5, 6, 11 and 12 showed that the films having a large contact angle, such as polybutadiene and pitch, were found to be effective in improving the cycle life, although they were not fluorine-based films. From the foregoing, it can be concluded that the films including a fluorine-based film material do not necessarily improve the cycle characteristics of the batteries and it is the size of the contact angle that affects the cycle characteristics.

The decrease in discharge capacity of the battery was improved further when the electrode material of the present invention was used in both of the positive electrode and the negative electrode of the battery as in samples 13 to 16.

Also in the samples in which a film was formed on the surface of the active material using a liquid containing no conductive agent, such as samples 17 and 18, the decrease in capacity was improved relative to sample 29 of the comparative example. This shows that it is possible to embed a conductive agent in a film during the rolling step in the production of an electrode plate, without previously including a conductive agent in a film that is to be formed on the surface of the active material. Accordingly, the conductivity is ensured, while the formation of a film is prevented. Additionally, although a film was formed on both of the positive electrode active material and the negative electrode active material in samples 17 and 18, the same improvement also was achieved when a film was formed on only one of the positive electrode active material and the negative electrode active material.

A more significant improvement in cycle life than that of sample 29 of the comparative example also was observed in samples 19 to 24, in which the films contained a binder. This indicates that the addition of a binder to the film does not hinder the effect of improving the cycle life.

The decrease in discharge capacity was suppressed more in samples 25 to 27, in which the active material layer was impregnated with the dispersion of the film material, as compared with samples 6, 12, 16 and 28. In addition, sample 25 showed a more significant improvement in the cycle life than sample 29 of the comparative example. By observing the cross-sections of the active material layers, it was confirmed that a film was formed on 10% to 50% of the surface of the active material particles in these samples. It seems that such a partial film is formed because the film material permeating the active material layer forms a liquid pool in the vicinity of the area of contact between the particles of the active material and the conductive agent in the active material layer by capillary condensation.

Although LiCoO₂ was used as the positive electrode active material in the above-described examples, similar effects also can be achieved by using a lithium-containing composite oxide in which Co is partially or entirely replaced by at least one or more different transition metals such as Mn, Ni or Fe.

A similar effect also can be achieved by using a different active material as the negative electrode active material, in place of a mesophase pitch-based carbon fiber powder. For example, it is possible to use a powder containing a metal that can be alloyed with lithium, a powder of a metal partially replaced by a transition metal that can be alloyed with lithium or a powder containing a compound that can be partially alloyed with lithium.

### Example 2

Evaluation of Film Materials

First, the affinity to a non-aqueous electrolyte was examined for six types of film materials. Specifically, film material layers (underlayers) were formed first by applying liquids containing the film materials onto aluminum foil serving as a positive electrode current collector and copper foil serving as a negative electrode current collector and then dried. Next, a non-aqueous electrolyte was added dropwise to these film material layers, and the contact angle formed between the surface of each of the film material layers and the non-aqueous electrolyte was measured. As the non-aqueous electrolyte, a non-aqueous electrolyte in which LiPF₆ was dissolved at a concentration of 1 M in a mixed solvent of ethylene carbonate and methyl ethyl carbonate with a volume ratio of 1:2 was used.

As the liquids containing the film materials, the following were used:
(1) fluorine-based silane compound/fluorine solvent solution (trademark “KP-801”, manufactured by Shin-Etsu Chemical Co. Ltd.);
(2) fluorine-based surface treating agent/fluorine solvent solution (trademark “KY-8”, manufactured by Shin-Etsu Chemical Co. Ltd);
(3) alkoxysilane/propanol solution (trademark “Biowater guard M”, manufactured by Shin-Etsu Chemical Co. Ltd);
(4) fluorine-based coating agent (trade mark “DAIFREE A441”, manufactured by DAIKIN INDUSTRIES, LTD.);
(5) polybutadiene/xylene solution; and
(6) pitch/toluene solution.

In the following, reference numerals (1) to (6) occasionally may be used to denote these films or liquids. The results of the measurement are shown in TABLE 3.

TABLE 3

organic films used and contact angles

| current collector | (1) | (2) | (3) | (4) | (5) | (6) |
|---|---|---|---|---|---|---|
| aluminum foil | 62° | 35° | 30° | 50° | 45° | 50° |
| copper foil | 60° | 36° | 33° | 51° | 42° | 49° |

As can be seen from the results of TABLE 3, some of the fluorine-based film materials had a large contact angle, whereas others had a small contact angle.

As described below, various electrode plates were produced using the above-described liquids (1) to (6). Then, non-aqueous electrolyte secondary batteries (capacity: about 1800 mAh) were produced using these electrode plates, and their characteristics were evaluated.

Sample 30

In sample 30, an underlayer was formed on a positive electrode current collector. First, acetylene black was dispersed in (1) fluorine-based silane compound/fluorine solvent solution such that the weight ratio of acetylene black after drying was 20 wt %. The dispersion was applied onto both sides of aluminum foil (having a thickness of 15 μm) and then dried, forming an underlayer. The thickness of the underlayer after drying approximately corresponded to several molecular layers of the constituent molecules of the film material used.

Next, 100 parts by weight of a lithium cobaltate (LiCoO₂) powder as a positive electrode active material, 2.5 parts by weight of acetylene black and 2.5 parts by weight of graphite were mixed in a Henschel mixer. This mixture was dispersed in a solution in which 3 parts by weight of polyvinylidene fluoride (PVDF) serving as a binder was dissolved in N-methyl-2-pyrrolidone, producing a positive electrode slurry. This slurry was applied onto the underlayer, then dried and further rolled. Thus, a positive electrode in which an active material layer (having a single-side thickness of 70 μm and a total thickness of 140 μm) was formed on both sides of the current collector was produced. The filling density of the active material of this positive electrode was 3.3 g/cm³.

Next, a negative electrode was produced as follows. First, 100 parts by weight of a mesophase pitch-based carbon fiber powder (having an average fiber diameter of 7 μm and an average fiber length of 18 μm) and 4 parts by weight of polyvinylidene fluoride (PVDF) serving as a binder were dispersed in N-methyl-2-pyrrolidone, producing a negative electrode slurry. This negative electrode slurry was applied onto both sides of copper foil (having a thickness of 12 μm), then dried and further rolled. Thus, a negative electrode in which the active material layer had a single-side thickness of 70 μm and the filling density of the active material was 1.4 g/cm³ was produced.

Next, the positive electrode, the negative electrode and a separator (porous film made of polyethylene) were wound in a spiral fashion such that the separator was sandwiched between the positive electrode and the negative electrode, producing an electrode assembly. This electrode assembly was housed in a case made of stainless steel, together with a non-aqueous electrolyte. The non-aqueous electrolyte was prepared by dissolving one mole of lithium hexafluorophosphate in one liter of a mixed solvent of ethylene carbonate and methyl ethyl carbonate (mixing volume ratio=1:2). Finally, the case was sealed, producing a cylindrical secondary battery (sample 30) as shown in FIG. 1.

Samples 31 to 35

Samples 31 to 35 were different from Sample 30 only in that they were produced by changing the liquid serving as the material of the underlayer of the positive electrode. The underlayer of sample 31 was formed using a liquid in which acetylene black was dispersed in (2) fluorine-based surface treating agent/fluorine solvent solution such that the weight ratio of acetylene black after drying was 20 wt %. The underlayer of sample 32 was formed using a liquid in which acetylene black was dispersed in (3) alkoxysilane/propanol solution such that the weight ratio of acetylene black after drying was 20 wt %. The underlayer of sample 33 was formed using a liquid in which acetylene black was dispersed in (4) fluorine-based coating agent such that the weight ratio of acetylene black after drying was 20 wt %. The underlayer of sample 34 was formed using a liquid in which acetylene black was dispersed in (5) polybutadiene/xylene solution such that the weight ratio of acetylene black after drying was 30 wt %. The underlayer of sample 35 was produced using a liquid in which acetylene black was dispersed in (6) pitch/toluene solution such that the weight ratio of acetylene black after drying was 30 wt %.

In the case of using the liquids (2) to (4), the thickness of the underlayer after drying approximately corresponded to several molecular layers of the constituent molecules of the film material used. In the case of using the liquids (5) and (6), the thickness of the underlayer after drying was about 3 μm.

Secondary batteries (samples 31 to 35) were produced in the same manner as in sample 30, except that the underlayer was formed on the positive electrode current collector as described above.

Sample 36

In sample 36, an underlayer was formed only on a negative electrode current collector.

100 parts by weight of a lithium cobaltate (LiCoO₂) powder as a positive electrode active material, 2.5 parts by weight of acetylene black and 2.5 parts by weight of graphite were mixed in a Henschel mixer. This mixture was dispersed in a solution in which 3 parts by weight of polyvinylidene fluoride (PVDF) serving as a binder was dissolved in N-methyl-2-pyrrolidone, producing a positive electrode slurry. This slurry was applied onto both sides of aluminum foil (having a thickness of 15 μm), then dried and further rolled. Thus, a positive electrode in which an active material layer (having a single-side thickness of 70 μm and a total thickness of 140 μm) was formed on both sides of the current collector was produced. The filling density of the active material of this positive electrode was 3.3 g/cm³.

A negative electrode was produced as follows. First, acetylene black was dispersed in (1) fluorine-based silane compound/fluorine solvent solution such that the weight ratio of acetylene black after drying was 15 wt %. The dispersion was applied onto both sides of copper foil (having a thickness of 12 μm) and then dried, forming an underlayer. The thickness of the underlayer after drying approximately corresponded to several molecular layers of the constituent molecules of the film material used.

Next, 100 parts by weight of a mesophase pitch-based carbon fiber powder (having an average fiber diameter of 7 μm and an average fiber length of 18 μm) and 4 parts by weight of polyvinylidene fluoride (PVDF) serving as a binder were dispersed in N-methyl-2-pyrrolidone, producing a negative electrode slurry. This negative electrode slurry was applied onto the underlayer on the copper foil, then dried and further rolled. Thus, a negative electrode in which an active material layer (having a single-side thickness of 70 μm and a total thickness of 140 μm) was formed on both sides of the current collector was produced. The filling density of the active material of this negative electrode was 1.4 g/cm³.

A cylindrical secondary battery (sample 36) as shown in FIG. 1 was produced in the same manner as in sample 30, except that the positive electrode and the negative electrode were produced as described above.

Samples 37 to 41

Samples 37 to 41 were different from sample 36 only in that they were produced by changing the liquid serving as the material of the underlayer of the negative electrode. The underlayer of sample 37 was formed using a liquid in which acetylene black was dispersed in (2) fluorine-based surface treating agent/fluorine solvent solution such that the weight ratio of acetylene black after drying was 15 wt %. The underlayer of sample 38 was formed using a liquid in which acetylene black was dispersed in (3) alkoxysilane/propanol solution such that the weight ratio of acetylene black after drying was 15 wt %. The underlayer of sample 39 was formed using a liquid in which acetylene black was dispersed in (4) fluorine-based coating agent such that the weight ratio of acetylene black after drying was 15 wt %. The underlayer of sample 40 was formed using a liquid in which acetylene black was dispersed in (5) polybutadiene/xylene solution such that the weight ratio of acetylene black after drying was 20 wt %. The underlayer of sample 41 was formed using a liquid in which acetylene black was dispersed in (6) pitch/toluene solution such that the weight ratio of acetylene black after drying was 20 wt %.

In the case of using the liquids (2) to (4), the thickness of the underlayer after drying approximately corresponded to several molecular layers of the constituent molecules of the film material used. In the case of using the liquids (5) and (6), the thickness of the underlayer after drying was about 3 μm.

Secondary batteries (samples 37 to 41) were produced in the same manner as in sample 36, except that the underlayer was formed on the negative electrode current collector as described above.

Samples 42 to 45

In samples 42 to 45, an underlayer was formed on both of a positive electrode current collector and a negative electrode current collector. Specifically, sample 42 was a sample using the liquid (1), and was formed using the positive electrode of sample 30 and the negative electrode of sample 36. Sample 43 was a sample using the liquid (4), and was formed using the positive electrode of sample 33 and the negative electrode of sample 39. Sample 44 was a sample using the liquid (5), and was formed using the positive electrode of sample 34 and the negative electrode of sample 40. Sample 45 was a sample using the liquid (6), and was formed using the positive electrode of sample 35 and the negative electrode of sample 41. Secondary batteries (samples 42 to 45) were produced in the same manner as in sample 30, except that the above-described positive electrode and negative electrode were used.

Sample 46

Sample 46 was different from sample 30 only in that it was produced by changing the liquid serving as the material of the underlayer of the positive electrode. Here, an underlayer was formed using a liquid containing a binder.

First, a dispersion was prepared by mixing (1) fluorine-based silane compound/fluorine solvent solution, acetylene black and N-methyl-2-pyrrolidone (NMP) in which polyvinylidene fluoride (PVDF) was dissolved. This dispersion was prepared such that the ratio of the fluorine-based silane compound was 10 wt % and the weight ratio of acetylene black to the binder was 2:1 in the underlayer after drying. This dispersion was applied onto both sides of aluminum foil (having a thickness of 15 μm) serving as a positive electrode current collector and then dried, forming an underlayer (having a thickness of about 5 μm).

A secondary battery (sample 46) was produced in the same manner as in sample 30, except that the underlayer was formed on the positive electrode current collector as described above.

Sample 47

Sample 47 was different from sample 30 only in that it was produced by changing the liquid serving as the material of the underlayer of the positive electrode. Here, an underlayer was formed using a liquid containing a binder.

First, a dispersion was prepared by mixing (6) pitch/toluene solution, acetylene black and N-methyl-2-pyrrolidone (NMP) in which polyvinylidene fluoride (PVDF) was dissolved. This dispersion was prepared such that the weight ratio of the pitch was 10 wt % and that the weight ratio of acetylene black to the binder was 2:1 in the underlayer after drying. This dispersion was applied onto both sides of aluminum foil (having a thickness of 15 μm) serving as a positive electrode current collector and then dried, forming an underlayer (having a thickness of about 5 μm).

A secondary battery (sample 47) was produced in the same manner as in sample 30, except that the underlayer was formed on the positive electrode current collector as described above.

Sample 48

Sample 48 was different from sample 36 only in that it was produced by changing the liquid serving as the material of the underlayer of the negative electrode. Here, an underlayer was formed using a liquid containing a binder.

First, a dispersion was prepared by mixing (1) fluorine-based silane compound/fluorine solvent solution, acetylene black and N-methyl-2-pyrrolidone (NMP) in which polyvinylidene fluoride (PVDF) was dissolved. This dispersion was prepared such that the weight ratio of the fluorine-based silane compound was 10 wt % and that the weight ratio of acetylene black to the binder was 2:1 in the underlayer after drying. This dispersion was applied onto both sides of copper foil (having a thickness of 12 μm) serving as a negative electrode current collector and then dried, forming an underlayer (having a thickness of about 5 μm).

A secondary battery (sample 48) was produced in the same manner as in sample 36, except that the underlayer was formed on the negative electrode current collector as described above.

Sample 49

Sample 49 was different from sample 36 only in that it was produced by changing the liquid serving as the material of the underlayer of the negative electrode. Here, an underlayer was formed using a liquid containing a binder.

First, a dispersion was prepared by mixing (6) pitch/toluene solution, acetylene black and N-methyl-2-pyrrolidone (NMP) in which polyvinylidene fluoride (PVDF) was dissolved. This dispersion was prepared such that the weight ratio of the pitch was 10 wt % and that the weight ratio of acetylene black to the binder was 2:1 in the underlayer after drying. This dispersion was applied onto both sides of copper foil (having a thickness of 12 μm) serving as a negative electrode current collector and then dried, forming an underlayer (having a thickness of about 5 em).

A secondary battery (sample 49) was produced in the same manner as in sample 36, except that the underlayer was formed on the negative electrode current collector as described above.

Sample 50

In sample 50, an underlayer containing a binder was formed on both of the positive electrode current collector and the negative electrode current collector. Specifically, the positive electrode of sample 46 and the negative electrode of sample 48 were used. A secondary battery (sample 50) was produced in the same manner as in sample 30, except that these electrode plates were used.

Sample 51

In sample 51, an underlayer containing a binder was formed on both of the positive electrode current collector and the negative electrode current collector. Specifically, the positive electrode of sample 47 and the negative electrode of sample 49 were used. A secondary battery (sample 51) was produced in the same manner as in sample 30, except that these electrode plates were used.

Sample 52

Sample 52 is a comparative example in which no underlayer was formed in either the positive electrode or the negative electrode. A secondary battery (sample 52) was produced in the same manner as in sample 30, except that the underlayer was not formed.

Evaluation of Battery Characteristics

The thus formed 23 types of samples were subjected to 500 repeated charge/discharge cycles at a current of 1800 mA and a temperature of 20° C. Then, the discharge capacity was measured until the battery voltage dropped from 4.2 V to 3.0 V after predetermined cycle numbers had elapsed. The cycle characteristics of each sample were evaluated from the change in this discharge capacity. The results of the measurement are shown in TABLE 4.

TABLE 4

| | | | elapsed cycle number and | | | | |
|---|---|---|---|---|---|---|---|
| | underlayer | | discharge capacity (mAh/cell) | | | | |
| | positive | negative | | | 50 | 200 | |
| | electrode | electrode | 1 cycle | 10 cycles | cycles | cycles | 500 cycles |
| sample 30 | (1) | none | 1812 | 1793 | 1721 | 1594 | 1280 |
| sample 31 | (2) | none | 1805 | 1786 | 1716 | 1390 | 711 |
| sample 32 | (3) | none | 1810 | 1788 | 1718 | 1385 | 698 |
| sample 33 | (4) | none | 1801 | 1781 | 1718 | 1565 | 1230 |
| sample 34 | (5) | none | 1808 | 1785 | 1721 | 1560 | 1180 |
| sample 35 | (6) | none | 1806 | 1782 | 1718 | 1561 | 1210 |
| sample 36 | none | (1) | 1810 | 1785 | 1715 | 1562 | 1222 |
| sample 37 | none | (2) | 1805 | 1783 | 1712 | 1375 | 702 |
| sample 38 | none | (3) | 1803 | 1784 | 1713 | 1373 | 690 |
| sample 39 | none | (4) | 1808 | 1783 | 1714 | 1555 | 1215 |
| sample 40 | none | (5) | 1802 | 1780 | 1712 | 1548 | 1201 |
| sample 41 | none | (6) | 1811 | 1284 | 1715 | 1552 | 1218 |
| sample 42 | (1) | (1) | 1805 | 1790 | 1736 | 1610 | 1365 |
| sample 43 | (4) | (4) | 1812 | 1794 | 1740 | 1612 | 1359 |
| sample 44 | (5) | (5) | 1803 | 1784 | 1712 | 1576 | 1312 |
| sample 45 | (6) | (6) | 1801 | 1780 | 1730 | 1580 | 1332 |
| sample 46 | (1) | none | 1812 | 1793 | 1721 | 1594 | 1280 |
| sample 47 | (6) | none | 1805 | 1786 | 1716 | 1590 | 1277 |
| sample 48 | none | (1) | 1810 | 1791 | 1712 | 1565 | 1232 |
| sample 49 | none | (6) | 1801 | 1785 | 1713 | 1558 | 1224 |
| sample 50 | (1) | (1) | 1812 | 1795 | 1735 | 1612 | 1362 |
| sample 51 | (6) | (6) | 1806 | 1792 | 1725 | 1598 | 1328 |
| sample 52 | none | none | 1810 | 1785 | 1714 | 1371 | 686 |

As can be seen from the results of TABLE 4, the values of the discharge capacity up to 50 cycles in samples 30 to 45 were substantially the same, and furthermore, there was little difference between these values and the value of the comparative example (sample 52). However, a difference occurred in the discharge capacity after 200 cycles had elapsed, and this difference became significant at 500 cycles.

Particularly, the decrease in discharge capacity was significantly improved in the samples in which (1) fluorine-based silane compound/fluorine solvent solution (trademark “KP-801”, manufactured by Shin-Etsu Chemical Co. Ltd.), (4) fluorine-based coating agent (trademark “DAIFREE A441”, manufactured by DAIKIN INDUSTRIES, LTD.), (5) polybutadiene/xylene solution and (6) pitch/toluene solution were used to form the underlayers. As shown in TABLE 3, the organic films formed from these film materials had a contact angle of more than 40° with the electrolyte. This showed that the use of a film material having a large contact angle, i.e., a low affinity to the electrolyte to form the underlayer could improve the cycle life of the battery significantly.

On the other hand, the cycle characteristics hardly were improved in the samples in which (2) fluorine-based surface treating agent/fluorine solvent solution (trademark “KY-8”, manufactured by Shin-Etsu Chemical Co. Ltd) or (3) alkoxysilane/propanol solution was used form the underlayers. From these results, it seems that some of the fluorine-based film materials are effective, whereas others are not, and that it is the size of the contact angle that affects the cycle characteristics.

The decrease in discharge capacity with charge/discharge cycles was improved further in samples 42 to 45 and samples 50 to 51, which used the underlayer in both of the positive electrode and the negative electrode of the battery.

A significant improvement in cycle life was observed also in samples 46 to 51, in which a binder was added to the underlayer, showing that the effects of the present invention could be achieved also in the case of adding a binder to the underlayer.

### Example 3

Sample 53

In sample 53, an underlayer was formed on a positive electrode current collector. First, acetylene black was dispersed in (1) fluorine-based silane compound/fluorine solvent solution such that the weight ratio of acetylene black after drying was 20 wt %. The dispersion was applied onto both sides of aluminum foil (having a thickness of 15 μm) and then dried, forming an underlayer. The thickness of the underlayer after drying approximately corresponded to several molecular layers of the constituent molecules of the film material used.

A film was formed on the surface of a positive electrode active material as follows. First, acetylene black was dispersed in (1) fluorine-based silane compound/fluorine solvent solution such that the weight ratio of acetylene black after drying was 20 wt %. This dispersion was sprayed to a lithium cobaltate (LiCoO₂) powder serving as an active material such that the ratio of the polymer (1) to the active material was 0.05 wt % to 3 wt % and then dried. Thus, a film was formed on a portion of the active material particles. The thickness of this film after drying approximately corresponded to several molecules of the polymer.

The obtained electrode material was used as a positive electrode active material of a lithium secondary battery. 100 parts by weight of this electrode material, 2.5 parts by weight of acetylene black and 2.5 parts by weight of graphite were mixed in a Henschel mixer. This mixture was dispersed in a solution in which 3 parts by weight of polyvinylidene fluoride (PVDF) serving as a binder was dissolved in N-methyl-2-pyrrolidone, producing a positive electrode slurry. This slurry was applied onto the underlayer, then dried and further rolled. Thus, a positive electrode in which an underlayer and an active material layer (having a single-side thickness of 70 μm and a total thickness of 140 μm) were formed on both sides of the current collector was produced. The filling density of the active material of this positive electrode was 3.3 g/cm³.

Next, a negative electrode was produced as follows. First, 100 parts by weight of a mesophase pitch-based carbon fiber powder (having an average fiber diameter of 7 μm and an average fiber length of 18 μm) and 4 parts by weight of polyvinylidene fluoride (PVDF) serving as a binder were dispersed in N-methyl-2-pyrrolidone, producing a negative electrode slurry. This negative electrode slurry was applied onto both sides of copper foil (having a thickness of 12 μm), then dried and further rolled. Thus, a negative electrode in which the active material layer had a single-side thickness of 70 μm and the filling density of the active material was 1.4 g/cm³.

Next, the positive electrode, the negative electrode and a separator (porous film made of polyethylene) were wound in a spiral fashion such that the separator was sandwiched between the positive electrode and the negative electrode, producing an electrode assembly. This electrode assembly was housed in a case made of stainless steel, together with a non-aqueous electrolyte. The non-aqueous electrolyte was prepared by dissolving one mole of lithium hexafluorophosphate in one liter of a mixed solvent of ethylene carbonate and methyl ethyl carbonate (mixing volume ratio=1:2). Finally, the case was sealed, producing a cylindrical secondary battery (sample 53) as shown in FIG. 1.

Sample 54

In sample 54, an underlayer was formed only on a negative electrode current collector, a negative electrode material of the present invention was produced, and a secondary battery (sample 54) was produced using the negative electrode material. 100 parts by weight of a lithium cobaltate (LiCoO₂) powder as a positive electrode active material, 2.5 parts by weight of acetylene black and 2.5 parts by weight of graphite were mixed in a Henschel mixer. This mixture was dispersed in a solution in which 3 parts by weight of polyvinylidene fluoride (PVDF) serving as a binder was dissolved in N-methyl-2-pyrrolidone, producing a positive electrode slurry. This slurry was applied onto both sides of aluminum foil (having a thickness of 15 μm), then dried and further rolled. Thus, a positive electrode in which an active material layer (having a single-side thickness of 70 μm and a total thickness of 140 μm) was formed on both sides of the current collector was produced. The filling density of the active material of this positive electrode was 3.3 g/cm³.

A negative electrode was produced as follows. First, acetylene black was dispersed in (1) fluorine-based silane compound/fluorine solvent solution such that the weight ratio of acetylene black after drying was 15 wt %. This dispersion was applied onto both sides of copper foil (having a thickness of 12 μm) and then dried, forming an underlayer. The thickness of the underlayer after drying approximately corresponded to several molecular layers of the constituent molecules of the film material used.

A film was formed on the surface of a negative electrode active material. First, acetylene black was dispersed in (1) fluorine-based silane compound/fluorine solvent solution such that the weight ratio of acetylene black after drying was 15 wt %. This dispersion was sprayed to a mesophase pitch-based carbon fiber powder (having an average fiber diameter of 7 μm and an average fiber length of 18 μm) serving as a negative electrode active material such that the ratio of the polymer (1) to the active material was 0.1 wt % to 10 wt % and then dried. Thus, a film was formed on 50% to 80% of the surface of the negative electrode active material particles. The thickness of this film after drying approximately corresponded to several molecules of the polymer.

100 parts by weight of the thus obtained negative electrode material and 4 parts by weight of polyvinylidene fluoride (PVDF) serving as a binder were dispersed in N-methyl-2-pyrrolidone, producing a negative electrode slurry. This negative electrode slurry was applied onto the underlayer formed on the copper foil, then dried and further rolled. Thus, a negative electrode in which an underlayer and an active material layer (having a single-side thickness of 70 μm and a total thickness of 140 μm) were formed on both sides of the current collector was produced. The filling density of the active material of this negative electrode was 1.4 g/cm³.

A cylindrical secondary battery (sample 54) as shown in FIG. 1 was produced in the same manner as in sample 53, except that the positive electrode and the negative electrode were produced as described above.

Sample 55

Sample 55 was produced in the same manner as in sample 53, except that the positive electrode of sample 53 and the negative electrode of sample 54 were used.

Evaluation of Battery Characteristics

The thus formed three types of samples were subjected to 500 repeated charge/discharge cycles at a current of 1800 mA and a temperature of 20° C. Then, the discharge capacity was measured until the battery voltage dropped from 4.2 V to 3.0 V after predetermined cycle numbers had elapsed. The cycle characteristics of each sample were evaluated from the change in this discharge capacity. The results of the measurement are shown in TABLE 5.

TABLE 5

| | | | | | elapsed cycle number | | | | |
|---|---|---|---|---|---|---|---|---|---|
| | | | active | | and discharge | | | | |
| | underlayer | | material | | capacity (mAh/cell) | | | | |
| | positive | negative | positive | negative | 1 | 10 | 50 | 200 | 500 |
| | electrode | electrode | electrode | electrode | cycle | cycles | cycles | cycles | cycles |
| sample | (1) | none | (1) | none | 1809 | 1790 | 1720 | 1596 | 1313 |
| 53 | | | | | | | | | |
| sample | none | (1) | none | (1) | 1808 | 1784 | 1713 | 1565 | 1257 |
| 54 | | | | | | | | | |
| sample | (1) | (1) | (1) | (1) | 1800 | 1786 | 1733 | 1617 | 1401 |
| 55 | | | | | | | | | |

It was observed that the cycle characteristics were improved by forming an underlayer on the current collector and using the electrode plate in which a film was formed on the active material as in samples 53 to 54.

Additionally, the decrease in discharge capacity was reduced further in the case of using the electrode material of the present invention in both of the positive electrode and the negative electrode as in sample 55.

Although the preferred embodiments of the present invention have been described hereinabove by way of examples, the invention is not limited to the above-described embodiments and is applicable to other embodiments in accordance with the technical idea of the present invention.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A non-aqueous electrolyte secondary battery comprising: a positive electrode including a layer of active material particles; a negative electrode including a layer of active material particles; and a non-aqueous electrolyte,
wherein an organic film including a conductive agent and having a low affinity to the non-aqueous electrolyte is formed on a portion of at least one electrode selected from the positive electrode and the negative electrode.

2. The non-aqueous electrolyte secondary battery according to claim 1,
wherein the portion in which the organic film having a low affinity to the non-aqueous electrolyte is formed is a portion of a surface of particles constituting the layer of active material particles.

3. The non-aqueous electrolyte secondary battery according to claim 2,
wherein a proportion of an area covered by the organic film on the surface of the active material particles is at least 10% and less than 90%, on average.

4. The non-aqueous electrolyte secondary battery according to claim 1,
wherein said at least one electrode includes a current collector and an underlayer formed on a surface of the current collector, and the portion in which the organic film including the conductive agent and having a low affinity to the non-aqueous electrolyte is formed is the underlayer.

5. The non-aqueous electrolyte secondary battery according to claim 1,
wherein a contact angle formed by the portion in which the organic film is formed and the non-aqueous electrolyte is at least 200.

6. The non-aqueous electrolyte secondary battery according to claim 1,
wherein the organic film further includes a binder.

7. The non-aqueous electrolyte secondary battery according to claim 1,
wherein the organic film is formed by reacting or coating at least one selected from the group consisting of a fluorine-based silane compound, a fluorine-based coating agent, polybutadiene, pitch and a perfluoroalkyl ester of polyacrylic acid.

8. The non-aqueous electrolyte secondary battery according to claim 4,
wherein a contact angle formed by the organic film formed on the underlayer and the non-aqueous electrolyte is at least 20°.

9. The non-aqueous electrolyte secondary battery according to claim 4, wherein the layer of active material particles is electrically connected to the current collector via the conductive agent included in the underlayer.

10. The non-aqueous electrolyte secondary battery according to claim 4, wherein the underlayer further includes a binder.

11. The non-aqueous electrolyte secondary battery according to claim 9,
further comprising a conductive layer disposed between the underlayer including the conductive agent and the layer of active material particles,
wherein the layer of active material particles is formed on the underlayer with the conductive layer interposed between the layer of active material particles and the underlayer.

12. The non-aqueous electrolyte secondary battery according to claim 1, wherein each of the positive electrode and the negative electrode is an electrode that reversibly absorbs and desorbs lithium.

13. A method for producing a non-aqueous electrolyte secondary battery comprising a positive electrode including a layer of active material particles, a negative electrode including a layer of active material particles and a non-aqueous electrolyte, the method comprising:
forming at least one electrode selected from the positive electrode and the negative electrode with the active material particles after forming an organic film having a low affinity to the non-aqueous electrolyte on a surface of the active material particles.

14. A method for producing a non-aqueous electrolyte secondary battery comprising a positive electrode including a layer of active material particles, a negative electrode including a layer of active material particles and a non-aqueous electrolyte, the method comprising:
forming an active material layer including at least one active material selected from a positive electrode active material and a negative electrode active material on a current collector; and
impregnating the active material layer with a liquid including a film material having a low affinity to the non-aqueous electrolyte.

15. A method for producing a non-aqueous electrolyte secondary battery comprising a positive electrode including a layer of active material particles, a negative electrode including a layer of active material particles and a non-aqueous electrolyte, the method comprising:
forming an underlayer including an organic film having a low affinity to the non-aqueous electrolyte on a surface of a current collector of at least one electrode selected from the positive electrode and the negative electrode; and
forming an active material layer electrically connected to the current collector on the underlayer.

16. The method for producing a non-aqueous electrolyte secondary battery according to claim 15,
wherein, to form the underlayer, a liquid including a film material and a conductive agent is applied to a surface of the current collector.

17. The method for producing a non-aqueous electrolyte secondary battery according to claim 16,
wherein the liquid further includes a binder.

18. The method for producing a non-aqueous electrolyte secondary battery according to claim 15,
wherein, to form the active material layer, the active material layer is formed by applying a slurry including a conductive agent and an active material powder to the underlayer, and thereafter, the conductive agent is caused to penetrate the underlayer by applying pressure from a surface to an inside of the active material layer, thereby electrically connecting the active material layer and the current collector via the conductive agent.

19. The method for producing a non-aqueous electrolyte secondary battery according to claim 15,
wherein the step of forming the active material layer comprises the steps of
forming a conductive layer including a conductive agent on the underlayer; and
causing the conductive agent to penetrate the underlayer by applying pressure from a surface to an inside of the active material layer after forming the active material layer on the conductive layer, thereby electrically connecting the active material layer and the current collector via the conductive agent,
wherein the active material layer is formed on the underlayer with the conductive layer interposed between the active material layer and the underlayer.

20. An electrode material comprising active material particles for a non-aqueous electrolyte secondary battery,
wherein an organic film having a low affinity to the non-aqueous electrolyte is formed on a portion of a surface of the active material particles.

21. The electrode material for a non-aqueous electrolyte secondary battery according to claim 20,
wherein a contact angle formed by the organic film and the non-aqueous electrolyte is at least 20°.

22. The electrode material for a non-aqueous electrolyte secondary battery according to claim 20,
wherein the organic film further includes a conductive agent.

23. The electrode material for a non-aqueous electrolyte secondary battery according to claim 20,
wherein the organic film further includes a binder.

24. The electrode material for a non-aqueous electrolyte secondary battery according to claim 20,
wherein the organic film is formed by reacting or coating at least one selected from the group consisting of a fluorine-based silane compound, a fluorine-based coating agent, polybutadiene, pitch and a perfluoroalkyl ester of polyacrylic acid.

25. The electrode material for a non-aqueous electrolyte secondary battery according to claim 20,
wherein a proportion of an area covered by the organic film on a surface of the active material particles is at least 10% and less than 90%, on average.
